(19) United States
(12) Patent Application Publication
(10) Pub. No.: US 2022/0193927 A1
(43) Pub. Date: Jun. 23, 2022

(54) BRACKET USABLE FOR SOLAR PANEL MODULE INSTALLATION

(71) Applicant: Rosendin Electric, Inc., San Jose, CA (US)

(72) Inventors: William Paul Mazzetti, JR., San Francisco, CA (US); Charles Zhou, Alameda, CA (US)

(21) Appl. No.: 17/566,925

(22) Filed: Dec. 31, 2021

Related U.S. Application Data
(63) Continuation of application No. 17/206,468, filed on Mar. 19, 2021.
(60) Provisional application No. 63/133,014, filed on Dec. 31, 2020.
(60) Provisional application No. 63/044,939, filed on Jun. 26, 2020.

(51) Int. Cl. B25J 15/06; B25J 5/00; B25J 19/00; B25J 9/16; B25J 13/00; B25J 13/08; H02S 20/32; F24S 30/00; G05D 1/00; G05D 1/02

(52) U.S. Cl. CPC B25J 15/0616; B25J 5/005; B25J 19/0054; B25J 9/1679; B25J 9/1697; B25J 13/006; G05D 1/0231; H02S 20/32; F24S 30/00; B25J 9/162; B25J 9/1664; G05D 1/0088; B25J 13/087

(57) ABSTRACT

A multiple part bracket can be constructed to provide an electrical power connection and a mechanical attachment. The multiple part bracket includes an upper portion and a lower portion of the bracket constructed to be assembled together on an arm of a solar tracker in the field. The lower portion is adaptable in shape and dimensions to attach onto solar trackers from two or more different manufacturers in order to mechanically capture a solar panel module on the arm and to retain the solar panel module in place on the arm of the solar tracker. The multiple part bracket can be used with an autonomous ground vehicle with a robotic arm in order to autonomously install the multiple part bracket onto a solar tracker with the robotic arm.

### CROSS-REFERENCE

This application claims priority under 35 USC 119 to U.S. provisional patent application Ser. 63/133,014, filed: Dec. 31, 2020, titled: MULTIPLE PART BRACKET USABLE WITH AN AUTONOMOUS GROUND VEHICLE (AGV) FOR SOLAR PANEL INSTALLATION as well as under 35 USC 120 to U.S. patent application Ser. No. 17/206,468, filed Mar. 19, 2021, titled A ROBOTIC ARM COOPERATING WITH AN OFF-ROAD CAPABLE BASE VEHICLE, which claims priority under 35 USC 119 to both U.S. provisional patent application titled “An autonomous ground vehicle for solar panel installation,” filed Aug. 12, 2019, Ser. No. 62/992,468; and to U.S. provisional patent application titled “Autonomous ground vehicle (AGV) for solar panel installation,” filed Jun. 26, 2020, Ser. No. 63/044,939, where the disclosure of all of these patent applications are incorporated herein by reference in their entirety.

### TECHNICAL FIELD

Embodiments of this disclosure relate generally to solar power.

### BACKGROUND

Today, installing and removing solar modules in a solar farm experience many problems including a need to pause work at night, crews need to be trained because no uniform solar tracker and corresponding solar module exists as well as the workers in the crew can change; and thus, training may need to occur for each solar farm installation, a repetitive task performed over and over again can lead to human complacence and errors over time, and weather and bad conditions interfere with the work.

### SUMMARY

Provided herein are various methods, apparatuses, and systems for a bracket usable for solar panel module installation. In an embodiment, a multiple part bracket can be constructed to provide an electrical power connection and a mechanical attachment. The multiple part bracket includes an upper portion and a lower portion of the bracket constructed to be assembled together on an arm of a solar tracker in the field. The lower portion is adaptable in shape and dimensions to attach onto solar trackers from two or more different manufacturers in order to mechanically capture a solar panel module on the arm and to retain the solar panel module in place on the arm of the solar tracker. The multiple part bracket can be used with an autonomous ground vehicle with a robotic arm in order to autonomously install the multiple part bracket onto a solar tracker with the robotic arm.

Similarly, in an embodiment, a clip bracket can be constructed to be used with the autonomous ground vehicle with a robotic arm in order to autonomously install the clip bracket onto an arm of a fixed axis solar tracker with the robotic arm. The clip bracket can be constructed to mechanically secure a solar panel module onto the fixed axis solar tracker as well as make an electrical connection to another solar panel module with the clip bracket.

These and many more embodiments are discussed.

### DRAWINGS

FIG. 1A shows a bottom up perspective view of an embodiment of three example instances of a multiple part bracket connecting two adjacent solar panel modules.

FIG. 1B shows a magnified view of FIG. 1A of the multiple part bracket in the middle that connects the two adjacent solar panel modules on an arm of a single axis tracker with two clip brackets.

FIG. 2 illustrates a side view of an embodiment of the multiple part bracket with its upper portion and its lower portion that are adaptable in shape and dimensions to match the shape and dimensions of the arm of the solar tracker.

FIG. 3 shows a top down view perspective view of the two solar panels held securely adjoined in place by the three example instances of multiple part brackets as well as the extension sections of two of the multiple part brackets that extend long enough so that an adjacent solar panel can connect to one or more clip brackets incorporated into the extension section of the multiple part bracket to secure mechanically in place with the neighboring/next solar panel module.

FIG. 4 illustrates an embodiment of the multiple part bracket and its upper portion of the multiple part bracket and a small section of the clip bracket protruding up in order to make a mechanical mating to a solar panel module.

FIG. 5 illustrates a side view of three example multiple part brackets aligned on an embodiment of one arm, round in shape, of a solar tracker.

FIG. 6 illustrates a bottom view of three example multiple part brackets aligned on an embodiment of an arm of a solar access tracker joining two solar panel modules.

FIG. 7 shows a top-down perspective view of an embodiment of the top metal plate with multiple stamped portions in that metal plate to receive insert clips.

FIG. 8 shows a perspective view of an embodiment of the lower shaped section with a semi-round shaped middle section and the threaded holes for the threaded rods that will expect to be at that will protrude upwards.

FIG. 9 shows a perspective view of an embodiment of the upper shaped section with four holes drilled into that metal bar along with a shaped portion of the upper shaped section that will be chosen from several different shaped instances of the upper shaped section to adapt to the shape of the arm of the solar axis tracker along with its dimensions of the standard arm from that particular solar tracker manufacturer.

FIG. 10 illustrates an example sketch of an embodiment of a multiple part bracket constructed to provide an electrical power connection and a mechanical attachment.

FIG. 11 shows a top down view of an embodiment of an automated ground vehicle with a robotic arm to work with the solar panel modules to put them in place on an arm of a solar tracker along with the multiple part bracket.

FIG. 12 illustrates an embodiment of a bottom up prospective view of an embodiment of multiple solar panel modules being set onto arms of a fixed axis solar tracker along with tens of clip brackets in place to clip into the recess cavity in a corresponding solar panel module as well as the clip bracket electrical adapters to connect to electrical power modules for each of the solar power panels.

FIG. 13 illustrates a top down perspective view of an embodiment of six example clip brackets each with two mechanical adapter portions of the clip bracket in order to clip into neighboring solar panel modules.

FIG. 14 shows a magnified view of an embodiment of two of the clip brackets from FIG. 13.

FIG. 15 illustrates a perspective view of a clip bracket along with the mechanical clip insert/adapter extending upward as well as the electrical power adapter.

FIG. 16A illustrates a straight on view of the clip bracket with a portion removed so that you can see the clips of the receiver portion of the clip bracket clipping the adapter portion of the clip bracket in place as well as into the into the solar panel module and the wheels to allow the solar panel module integrated into the clip bracket to assist in moving the attached solar panel module into place onto the arm of the solar access tracker.

FIG. 16B illustrates a side perspective view of another embodiment of the clip bracket with a C-channel clamp to slide along an arm of a fixed axis solar tracker and two electrical power adapters on top of the clip bracket that can also snap into place into an attached solar panel module.

FIG. 17A illustrates a top down perspective view of an embodiment of a clip bracket with one side of the mechanical adapter portion of the clip bracket snapping into place into the solar panel module and the other receiver portion of the clip bracket open to receive the recess hole of another solar panel module and/or mechanical adapter portion.

FIG. 17B shows a side perspective of an embodiment of a clip bracket with its an electrical power adapter on top.

FIG. 17C shows a side view of an embodiment of a clip bracket with electrical cords plugged into a power module of the solar panel module.

FIG. 18 illustrates a block diagram of an embodiment of an example autonomous ground vehicle with a robotic arm that can autonomously install one or more solar panel module installations onto a solar tracker.

FIG. 19 illustrates a block diagram of an embodiment of an example autonomous ground vehicle with the robotic arm with deck space to carry solar panel modules.

FIG. 20 illustrates a diagram of an embodiment of one or more computing devices that can be a part of the systems associated with the system and vehicles for the autonomous ground vehicle with the robotic arm for solar module installation onto a solar tracker.

FIG. 21 illustrates a block diagram of an embodiment of an example autonomous ground vehicle with the robotic arm and a coupled vehicle with deck space to carry solar panel modules.

While the design is subject to various modifications, equivalents, and alternative forms, specific embodiments thereof have been shown by way of example in the drawings and will now be described in detail. It should be understood that the design is not limited to the particular embodiments disclosed, but—on the contrary—the intention is to cover all modifications, equivalents, and alternative forms using the specific embodiments.

### DESCRIPTION

In the following description, numerous specific details can be set forth, such as examples of specific data signals, named components, number of frames, etc., in order to provide a thorough understanding of the present design. It will be apparent, however, to one of ordinary skill in the art that the present design can be practiced without these specific details. In other instances, well known components or methods have not been described in detail but rather in a block diagram in order to avoid unnecessarily obscuring the present design. Further, specific numeric references such as the first server, can be made. However, the specific numeric reference should not be interpreted as a literal sequential order but rather interpreted that the first server is different than a second server. Thus, the specific details set forth can be merely exemplary. The specific details can be varied from and still be contemplated to be within the spirit and scope of the present design. The term “coupled” is defined as meaning connected either directly to the component or indirectly to the component through another component.

A multiple part bracket 150 and/or a clip bracket 180 can be constructed to provide an electrical power connection and a mechanical attachment. The multiple part bracket 150 includes an upper portion and a lower portion of the bracket constructed to be assembled together on an arm of a solar tracker in the field. The lower portion is adaptable in shape and dimensions to attach onto solar trackers from two or more different manufacturers in order to mechanically capture a solar panel module on the arm and to retain the solar panel module in place on the arm of the solar tracker. The multiple part bracket 150 and/or a clip bracket 180 can be used with an autonomous ground vehicle with a robotic arm in order to autonomously install the multiple part bracket 150 onto a solar tracker with the robotic arm. The receiver portion of the clip bracket can be installed into a stamped open slot of the multiple-part bracket. The assembly of the clip bracket can have all the snap-fit mechanisms and electrical circuitry. The multiple-part bracket can be merely the stamped metal pieces (e.g. top metal plate, upper shaped section, lower shaped section) and associated hardware (e.g. threaded rods) to attach to an arm such as a torque-tube.

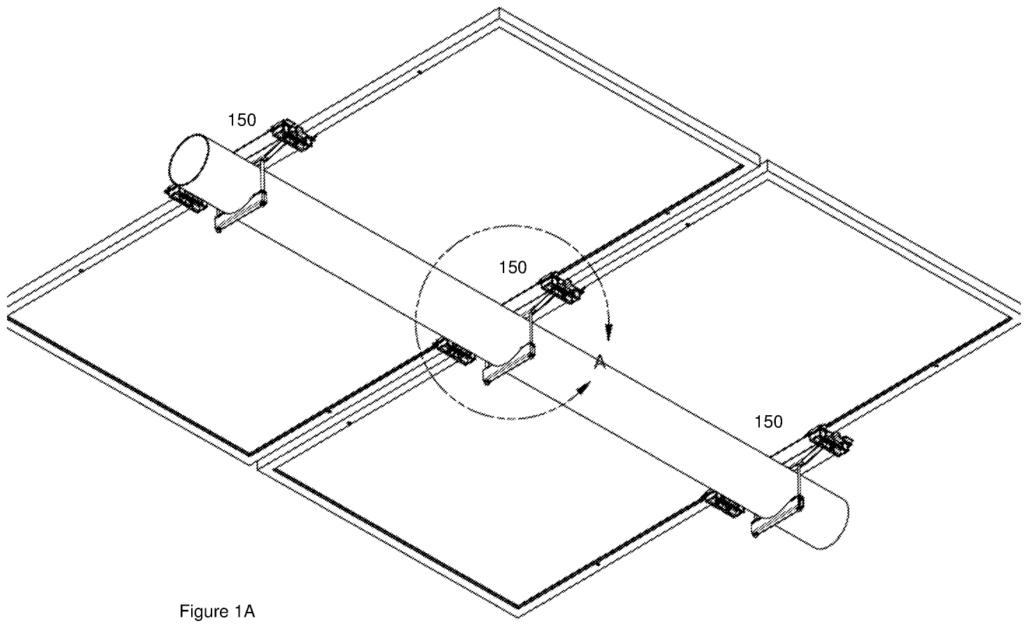

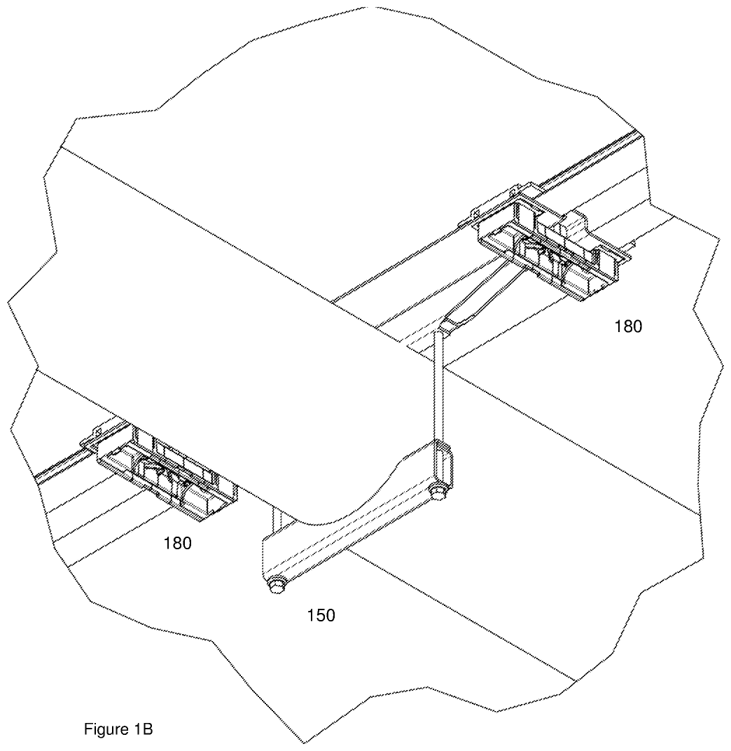

FIG. 1A shows a bottom-up perspective view of an embodiment of three example instances of a multiple part bracket connecting two adjacent solar panel modules.

The three individual multiple part brackets 150 connect two adjacent solar panel modules on an arm (e.g., torque tube) of, for example, a single axis tracker. Note, the solar panel modules and solar trackers can be arranged in rows and rows of solar panels mounted onto solar axis trackers. The solar axis trackers may be one or more of a fixed axis solar tracker, a single axis solar tracker, and a multiple-axis tracker.

Mechanically, the multiple part bracket 150 has two or more components including a lower portion of the multiple part bracket 150 and an upper portion of the multiple part bracket 150.

In an embodiment, the upper portion of a multiple part bracket 150 may be initially snapped into place in a solar panel module and then set onto an arm of a solar tracker. Each subsequent pair of the upper portion of a multiple part bracket 150 and solar panel module would then mechanically couple to a neighboring solar panel module via a clip bracket 180 incorporated into the extension section that extends out long enough past an edge of the solar panel module coupled to the clip bracket 180 incorporated into the extension section in order for the extension section of the multiple part bracket 150 to connect with an adjacent solar panel module. The lower portions of the multiple part bracket 150 are coupled to the upper portion of the multiple part bracket 150 to secure the multiple part bracket 150 onto an arm of the solar tracker. Alternatively, instances of the multiple part bracket 150 are placed along the arm(s) of, for example, each single-axis tracker at a distance spaced out to set each individual solar panel module in place. The solar panel module can be placed on two neighboring multiple part brackets 150.

Multiple types of brackets, clip brackets 180, and multiple part brackets 150 can be used to secure a solar panel module to a solar tracker. The multiple types of brackets can be used to secure the solar panel module to a solar tracker via an autonomous ground vehicle (AGV) with a robotic arm for solar panel installation, a cooperating fastening robot, a human, and any combination of these. Both the clip brackets 180 and multiple part brackets 150 are designed to allow the placement of a solar panel module onto an upper portion of a multiple part bracket 150 which is affixed to the arm of the solar axis tracker. Next, a fastener robotic and/or human can come later to mechanically clamp the brackets (and the mechanically attached solar panel module) permanently in place on the solar tracker by tightening a mechanical fastener screw and thereby clamping that bracket and its attached solar panel module into place on the arm of the solar tracker.

FIG. 1B shows a magnified view of FIG. 1A of the multiple part bracket in the middle that connects the two adjacent solar panel modules on an arm (e.g., torque tube) of a single axis tracker with two clip brackets. The clip bracket 180 and multiple part bracket 150 can work together. The stamped slots in the top metal plate can receive the clip bracket 180 to fit in that recess. The adapter portion of the clip bracket 180 can perform all of the mechanical (snap) fit and electrical connections. The clip bracket 180 can be designed to be installed permanently onto a purlin (e.g. box/C/I beam), and cooperate with the multiple part bracket 150 to adapt the clip brackets 180 to attach to an arm such as in a torque tube system. The upper portion of the multiple part bracket 150 making mechanical (snap) fit and electrical connections is mostly going to be describing the adapter portion of the clip bracket 180. The multiple part bracket also provides a bonding (electrical grounding) connection that is completed with the mechanical snap fit. It will bond the solar module frame with 150, which then is bonded to the arm/torque tube from contact by the upper/lower brackets & bolts. The multiple part bracket 150 has stamped openings to accept the receiver portion of the clip bracket 180. The receiver portion of the clip bracket 180 is be fastened to the top metal plate in the stamped slot sections. The receiver portion of the clip bracket 180 will straddle the “hump” and use two of the stamped holes.

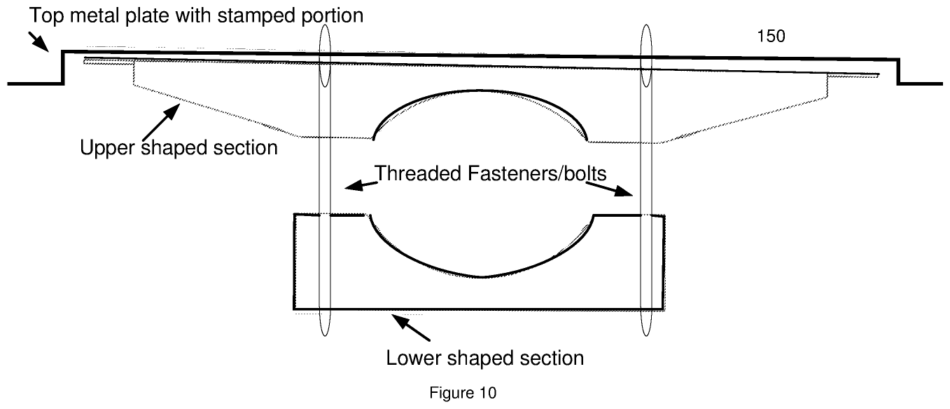

FIG. 10 illustrates an example sketch of an embodiment of a multiple part bracket constructed to provide an electrical power connection, grounding/bonding connection, and a mechanical attachment. As discussed, the multiple part bracket 150 includes an upper portion of the bracket and a lower portion of the bracket that are assembled together on an arm of the solar tracker in the field. The lower portion of the bracket is adaptable in shape and dimensions to attach onto solar trackers from two or more different manufacturers in order to mechanically capture a solar panel module and to retain the solar panel module in place on a solar tracker. The cavity formed between the upper shaped section and the lower shaped section is adaptable to match any arm (e.g., torque tube) of a single-axis tracker.

See FIG. 1B, the lower portion of the multiple part bracket has a U-shaped bolt construction with a lower shaped section that adapts its shape and dimensions to the shape and dimensions of the arm of the single-axis solar tracker made by that particular manufacturer. Note, the shape and dimensions of the arm of an example solar tracker from a first manufacturer differs from the shape and dimensions of the arm of another solar tracker from another manufacturer. Thus, multiple versions of the lower portion of the multiple part bracket 150 are manufactured in multiple different shapes and dimensions in order to be able to adapt to multiple different types of manufacturers' solar axis trackers. The multiple versions of the lower portion of the multiple part bracket 150 can all connect so that they connect in a common manner (such as a threaded rod) to the upper portion of the multiple part bracket 150.

Four example manufactured parts of the multiple part bracket 150 can be connected together. The top metal plate with stamped portions sits on top of the upper shaped section.

The upper shaped section has some threaded fastener bolts going through its structure as well as going through the lower shaped section. The shapes in the middle sections of the upper shaped section and in the lower shaped section are chosen in shape and dimensions to adapt to the arm of the solar access tracker that they are being mounted on.

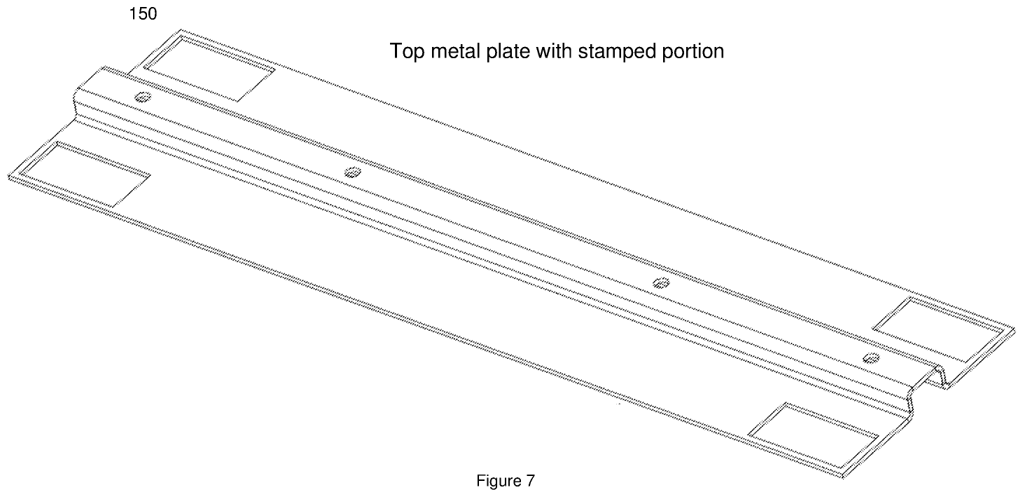

Again, FIGS. 7 through 10 show an embodiment of various individual pieces of the multiple part bracket 150 as they are manufactured and then put together in the factory to form the upper and lower portion of the multiple part bracket 150 which can be snapped together out in the field. FIG. 7 shows a top-down perspective view of an embodiment of the top metal plate with multiple stamped portions in that metal plate to receive insert clips. The example top metal plate has four stamped rectangles in the metal plate for the plastic/rubber coated clip brackets and their electrical clip and snapping connection to the solar panel module. The example top metal plate also has a raised section in the middle where the component of the upper shaped section can slide into. The extension portions are long enough to extend under the solar panel modules on the left and right so that they may mechanically secure together.

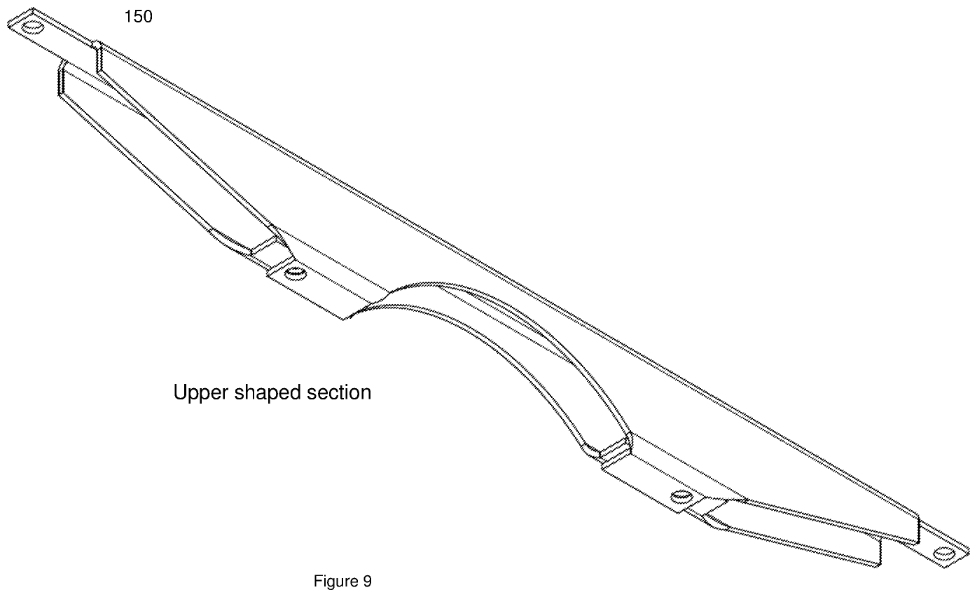

FIG. 9 shows a perspective view of an embodiment of the upper shaped section with four holes drilled/stamped into that metal bar along with a shaped portion of the upper shaped section that will be chosen from several different shaped instances of the upper shaped section to adapt to the shape of the arm of the solar axis tracker along with its dimensions of the standard arm from that particular solar tracker manufacturer. The upper portion of the multiple part bracket 150 can be constructed from the upper shaped section and the top metal plate with stamped portions in that metal plate.

Different versions of the upper shaped section can be manufactured to have dimensions and a shape that will fit onto the arm of a particular type of solar tracker.

The set of different versions of the upper shaped sections can then be manufactured to have dimensions and a shape that will fit onto the arm of any known type of solar tracker.

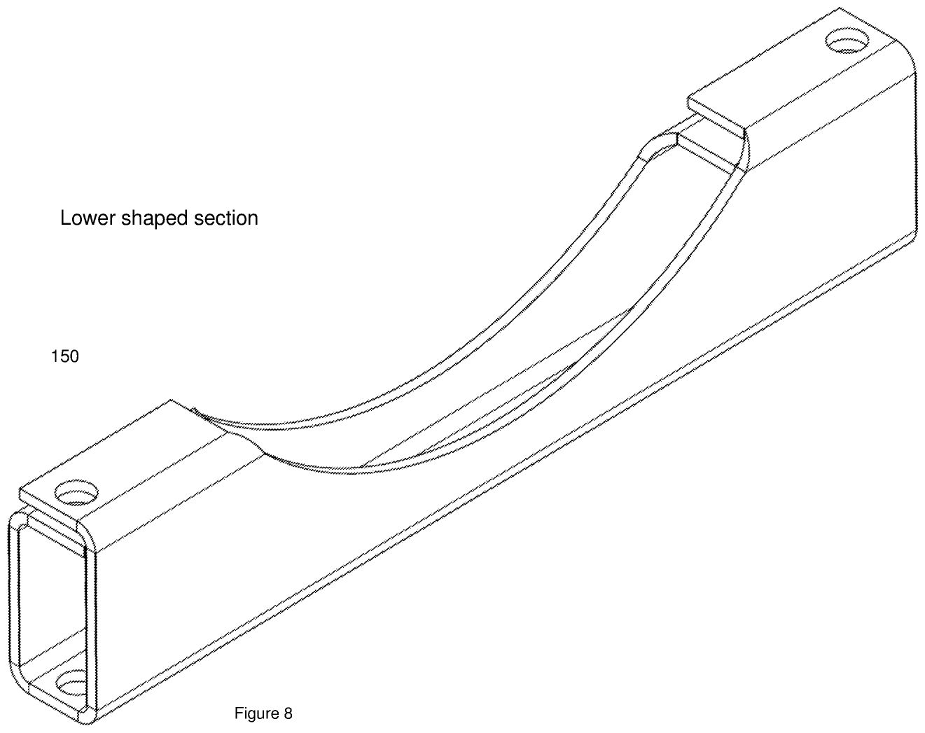

FIG. 8 shows a perspective view of an embodiment of the lower shaped section with a semi-round shaped middle section and the threaded holes for the threaded rods that will protrude upwards. Again, multiple versions of the lower shaped section are created in various shapes and dimensions so that the set of lower shaped sections are adaptable in shape and dimensions to attach onto the arms of solar trackers from two or more different manufacturers.

The upper portion of the multiple part bracket 150 can be constructed with an upper shaped section and a top metal plate with two or more stamped slots in the top metal plate. The upper section and top metal plate with stamped slots will mechanically couple with the lower shaped section only when the two are aligned. The upper shaped section and the top metal plate with the stamped slots are configured to mechanically couple with a lower shaped section in the lower portion of the multiple part bracket 150 via the use of threaded rods. The threaded rods in the lower shaped section are constructed to be inserted and torqued in place in the factory with at least one of i) nuts and ii) threaded inserts so that the threaded rods can go up and through both the upper shaped section and then through the top metal plate when installed on the arm in the field.

The lower portion of the bracket adapts its shape and dimensions to match the shape and dimensions of an arm of the solar tracker from that particular manufacturer.

The lower and upper portions of the multiple part bracket 150 can adapt to match the dimensions and shape of various manufacturers' arms such as a square tube, a round tube, a hex tube, etc. for the single-axis tracker.

Thus, an example lower piece of the bracket in the shape of a round tube is shown but a lower piece of the bracket could also be in the shape of a hex tube, a square tube, other shape, etc. implemented via the set of manufactured different instances of the lower shaped section of the bracket.

The lower portion of the multiple part bracket 150 can be constructed at the factory with the lower shaped section with the thread rods installed and torqued secure on the threaded rod on the bottom of the lower shaped section.

Each instance of the lower portion of the multiple part bracket 150 can be constructed to mate and connect to the same upper portion of the multiple part bracket 150 and use the same mechanical fastener to secure the multiple part bracket 150 onto the solar tracker of that particular manufacturer. The mechanical fastener can be, for example, a threaded bolt with nuts on the top and bottom of the threaded bolt, a screw mechanism, and any combination of both.

Threaded rods in the lower shaped section go through the lower shaped section and penetrate through the holes drilled through the upper shaped section and the top metal plate with stamped portion.

Referring back to FIG. 1B, the multiple part bracket with one or more clip brackets becomes a mechanical bracket and electrified clip solution that is designed to speed up the installation time on a solar panel onto a tracker by several minutes. The upper portion of the multiple part bracket 150 has the clip brackets inserted into the slots of the top metal plate in order to make a snap-fit connection into the recess of the solar panel module; and thereby, allow those solar panel modules to be installed onto various solar trackers from various different manufacturers. The upper portion of the multiple part bracket 150 with the clip brackets 180 inserted into the slots can also make electrical connections between solar panel modules. The multiple part bracket 150 incorporating the clip brackets 180 takes two separate tasks—panel mounting and wire stringing—and combines them to do it in one pass. The multiple part bracket 150 accomplishes this by both mechanically fastening the panel to the arm/torque tube and with the clip bracket 180 electrically stringing the electrical cords to connect to adjacent panels. The mechanical snap fit also creates a bonding connection so the module frame, brackets, and torque tube is bonded together. In addition to saved installation time, the multiple part bracket 150 incorporating the clip bracket 180 also provides a standardized attachment method that is adaptable to, for example, any torque tube-based single-axis tracker.

Again, the lower shaped section of the multiple part bracket 150 is manufactured in various shapes and dimensions to match standard arms (e.g., square tube, round tube, hex tube, etc.). Thus, an example lower piece of the bracket in the shape of a round tube is shown but a lower piece of the bracket could also be in the shape of a hex tube or square tube, and then the threaded rods allow any version of the lower shaped section to be used with the same upper portion of the multiple part bracket 150. The same bolts on the lower portion and upper portion of the multiple part bracket 150 can be used to secure the multiple part bracket 150 together on the solar tracker of any given manufacturer/solar tracker manufacturer.

Next, the top adapter portion of the clip bracket 180 lives within the footprint of the solar module frame and can attach to the receiver portion of the clip bracket 180 using a quick couple mechanism such as a clip. A top adapter portion of the clip bracket 180 can be integrated into the design of the solar module frame or installed as a separate piece at the panel factory. Having the top adapter portion of the clip bracket 180 to adapt to a solar panel module's shape and dimensions, the receiver portion of the clip bracket 180 to receive the adapter portion, and the remaining portions of the multiple part bracket 150 combine to make the solar panel module mounting virtually the same across all versions and internal shapes of the arm of a solar tracker, which leads to a standardized method of panel installation across multiple solar tracker manufacturers. The upper portion/adaptive portion of the clip bracket 180 is constructed to mechanically clamp and snap into place when mating to the solar panel module to this upper portion of the bracket. Note, solar panel modules from two or more different solar panel manufacturers can have different shaped mechanical clamping and snapping features for the bracket to snap into place. The lower portion of the multiple part bracket 150 is designed so it will positively square itself on the arm/torque tube (whatever shape that tube is), and the receiver holes in the upper shaped section will mechanically couple with the lower bracket only when the two are aligned. This positive location results in a much faster installation than the current process of using panel jigs/clamps to keep alignment throughout the row.

The multiple part bracket 150 plus the clip bracket 180 can be used together in solar panel module installs on a single axis and multiple axis solar tracker. The clip bracket 180 can be used by itself on fixed axis trackers.

The clip bracket 180 inserted into the slots of the top metal plate can include an electrical portion—wiring, electrical connectors, circuitry. The clip bracket 180 with its waterproof electrical portion inserted in the slots of the multiple part bracket 150 contains the electrical connections used to electrically connect adjacent solar panel modules electrically in series. In an embodiment, the waterproof electrical clip is constructed to make an electrified connection that is engaged at the same time as its mechanical connection.

Again, the waterproof electrical portion of the clip bracket 180 contains the electrical connections used to electrically connect adjacent panels in series. An adapter portion of the clip bracket 180 can contain the electrical cord which has a plug end that can be easily plugged into the electrical power panel of the attached and/or neighboring solar panel module. Alternatively, the adapter portion of clip bracket 180 with the electrical components replaces the junction box leads with an electrified connection that is engaged at the same time as its mechanical connection. The electrified lower bracket serves as the electrical jumper between adjacent panels. In an embodiment, the electrical portions and mechanical adaptor portions of the clip bracket can be integrated directly into the multiple part of bracket 150.

The upper module bracket has the electrical pathways attached to the module's junction box output. When upper and lower brackets are connected, the electrical connection is completed. This method can be preferable to the previous method of wire stringing because the electrical leads must be connected, dressed, and secured in the field to avoid damage in the wind. Any implementation of the waterproof electrical clip will completely eliminate this separate pass and field work, saving time and money.

Again, the mechanical adapter portion of the clip bracket 180 can make a one-snap-in clip for attachment to a solar panel.

The multiple part bracket 150 with its clip portion captures solar panel modules and retains them in the bracket. The design consists of a “core” bracket which can be built for a round, hexagonal, or square tube (shown is round).

The bracket can be slid along the tube of a single axis tracker to where it engages with the PV module, and then secures to the tube from below by torquing the two nuts. The multiple part bracket 150 can allow the modules to mount closer to each other, for example, as close as ˜⅛″. In an embodiment, the brackets are first torqued down, and the solar panel modules are then installed secondly by “snap fit”.

Autonomous robots can use the multiple part bracket 150, such as a speed clip, on single-axis solar trackers as well as potentially multiple axis solar trackers to secure solar panels onto that solar tracker, where the multiple part clip allows the panels to be installed on solar trackers from multiple different manufactures. The multiple part bracket 150 provides an energized (power, bonding/grounding, and mechanical) attachment for the solar panel mounting clip to, for example, a solar SAT (single-axis tracker). The multiple part bracket 150 provides a unique solar panel mounting solution for single-axis trackers and potentially multiple-axis solar trackers.

An extension section of the upper portion of the bracket extends out long enough past an edge of the solar panel mounted to that bracket in order for the clip bracket incorporated into the extension section to connect with an adjacent solar panel so that the clip bracket 180 can connect or otherwise clip into the two adjacent panels. The clip bracket 180 can connect or otherwise clip into each solar panel module in order to hold neighboring solar panel modules to abut together.

In addition, in an embodiment, the extension sections of the brackets can connect or otherwise clip into each other in order to form an electrical connection between two adjacent solar panel modules. In an embodiment, the top adapter portion of the clip bracket 180 has a waterproof electrical clip portion that contains the electrical connections used to electrically connect adjacent panels electrically in series (via a mating to another electrical power insert clip and/or via the use of an electrical cable that can plug and mate into the input/output electrical connection of a solar panel module).

The stamped open slots in the top metal plate in the upper portion of the multiple part bracket 150 can receive the clip bracket 180 as a plastic waterproof electrical power insert into these open slots. The clip bracket 180 as a waterproof electrical power insert can snap into place into the open slots in that top metal plate with stamped portions. In addition, the clip bracket is made of a sturdy and durable material to mechanically support the weight of the solar panel module in high winds.

The lower portion of the multiple part bracket 150 will have a U-bolt design when the lower shaped section and threaded rods are combined to connect and meet up with the upper portion of the multiple part bracket 150. This multiple part bracket 150 and later the clip bracket 180 make mechanical, electrical, and bonding connections simultaneously.

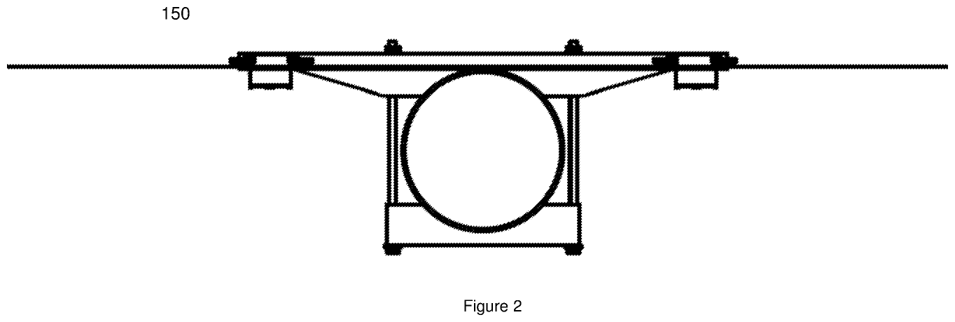

FIG. 2 illustrates a side view of an embodiment of the multiple part bracket with its upper portion and its lower portion that are adaptable in shape and dimensions to match the shape and dimensions of the arm of the solar tracker. The threaded rods protrude upward from the lower shaped section to protrude through the holes in the upper shaped section to be secured in place. The multiple part bracket 150 can be temporarily secured into place when the lower portion of the bracket snaps into the upper portion of the bracket. The multiple part bracket 150 can be permanently secured into place such as through a torquing of nuts onto bolts onto both ends of those threaded rods. Also, the electrical power insert clip protruding through the slots in the stamp metal top plate can be seen on both sides of the bracket snapped into the slots in order for them to mechanically mate and connect up to a recess in the solar panel module.

The multiple part bracket 150 is further constructed to use a mechanical fastener as part of the bracket to secure the solar panel module via clamping the solar panel module on the arm of the solar tracker as well as an electrical power insert clip with at least one of an electrical cord, a female electrical plug receptor, and an electrical clip to make an electrical connection to an adjacent solar panel.

Both the clip bracket 150 and multiple part bracket 150 designs can use mechanical fasteners (e.g., fastening screws, threaded inserts, and/or nuts with bolts combinations) to clamp and torque the bracket onto the arm (e.g., torque tube) of the solar tracker, whether the solar tracker is a single axis tracker or a fixed axis tracker. The mechanical fastener is integrated into the clip bracket 180 and the lower shaped section of the multiple part bracket 150 at the factory so as to eliminate loose parts such as nuts and bolts that would need to be installed in the field.

Both the clip bracket 180 design and the multiple part bracket 150 designs have a limited amount of loose components that have to be assembled in the field. Instead, all of the, for example, nuts torqued onto the lower portion of the multiple part bracket 150 can be installed, torqued, and checked for quality assurance/compliance to torquing amount in the factory.

The mechanical fastener (e.g., fastening screw) and the multiple parts of the bracket are integrated into a lower portion of the bracket and upper portion of the bracket and in the monolithic design into the clip bracket 180 in the factory setting versus sending a lot of loose parts to the field.

The top portion of the insert clip in the bracket has the protruding shape for a snap-fit to clip and clamp into the recess of the attaching solar panel module.

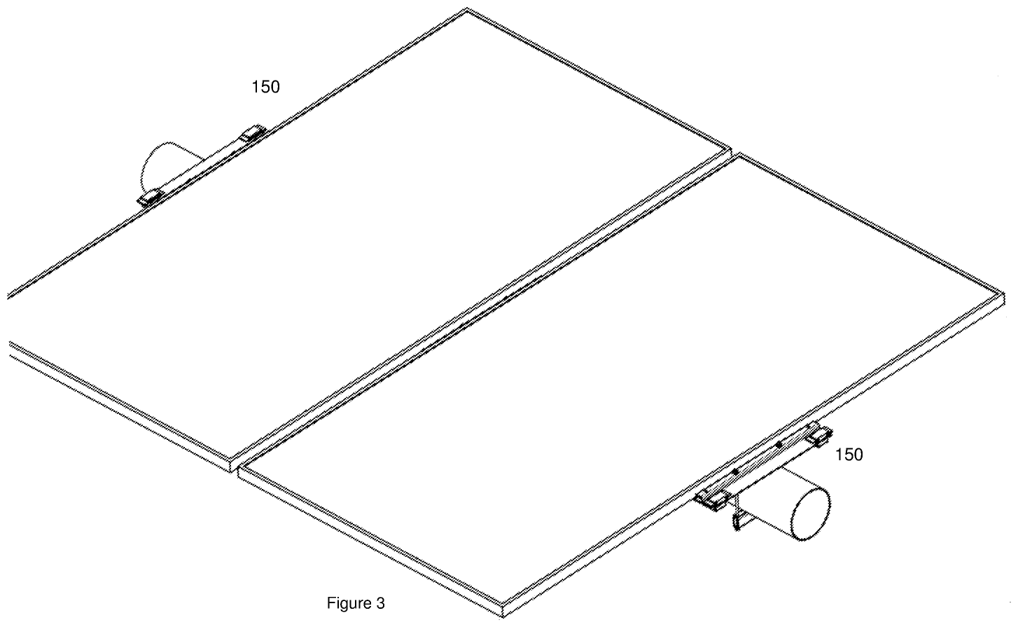

FIG. 3 shows a top-down view perspective view of the two solar panels held securely adjoined in place by the three example instances of multiple part brackets as well as the extension sections of two of the multiple part brackets that extend long enough so that an adjacent solar panel can connect to one or more clip brackets incorporated into the extension section of the multiple part bracket to secure mechanically in place with the neighboring/next solar panel module.

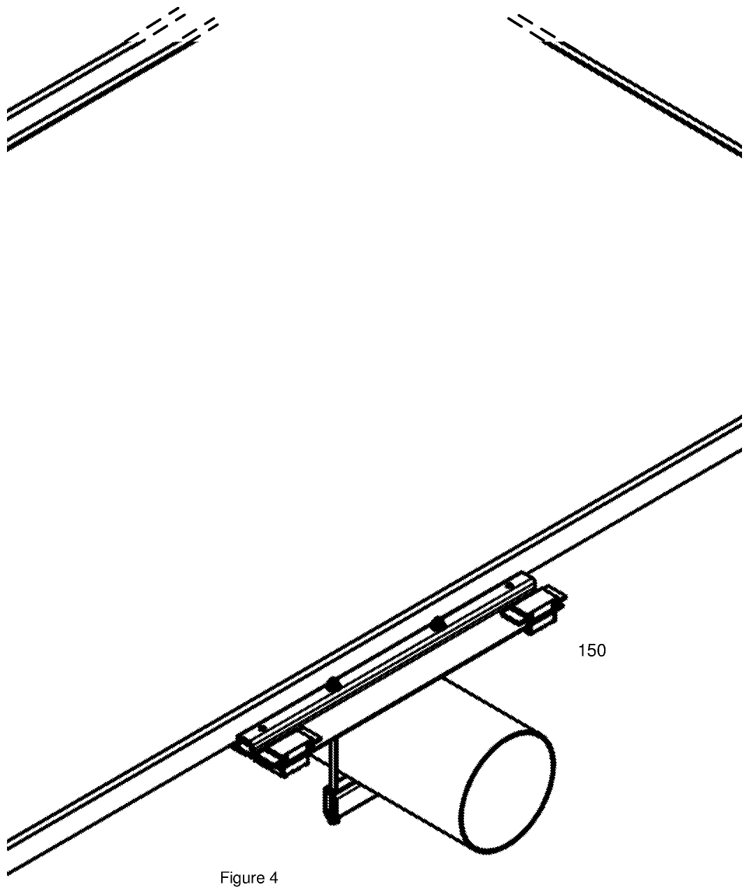

FIG. 4 illustrates an embodiment of the multiple part bracket and its upper portion of the multiple part bracket and a small section of the clip bracket protruding up in order to make a mechanical mating to a solar panel module. One side of the upper portion of the multiple part bracket 150 is shown snapped into place into the solar panel module (and thus currently hidden from view) where the other section of the insert clip in the upper portion of the multiple part bracket 150 is left exposed so that an adjacent solar panel module can snap into place onto this extension section of the upper portion of the multiple part bracket 150 that was left exposed.

The upper portion of the multiple part bracket 150 may have a protruding shape, such as a hexagon, arrow shaped clips, and other upward projections, so that when the protruding shape is pressed into a recessed cavity with clips in the solar panel module, then the solar panel module and the bracket will snap into place and be permanently connected to each other. The solar panel module and the bracket once snapped into place will be permanently connected to each other unless and until a specialty tool is applied that allows a user to pry back the clips to separate the protruding shape from the recess cavity of the solar panel module.

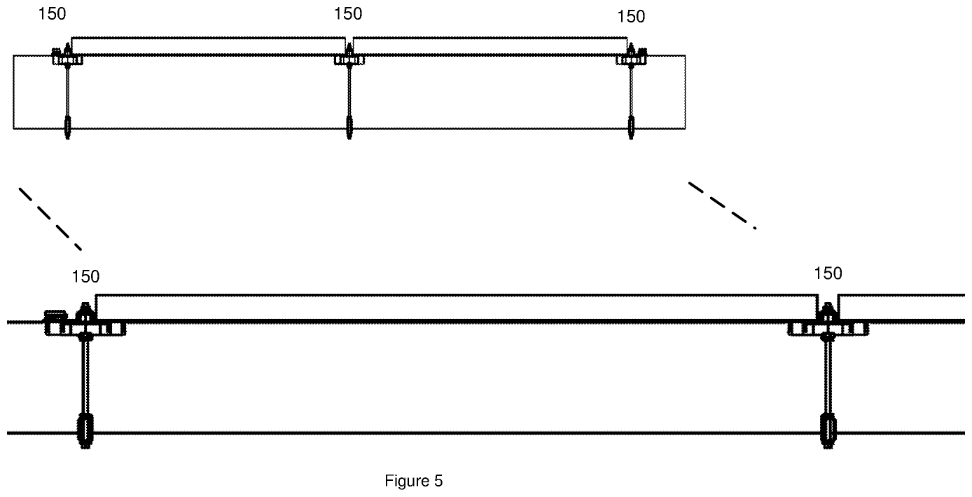

FIG. 5 illustrates a side view of three example multiple part brackets aligned on an embodiment of one arm, round in shape, of a solar tracker. The three multiple part brackets 150 mechanically and electrically connect two adjacent solar power panels. FIG. 5 also shows a magnification of one of the solar panel modules and two of the example multiple part brackets 150 when secured onto the arm of the solar access tracker with the solar panel module snapped mechanically into place onto extension sections the first and the second multiple part brackets 150. All of the multiple part brackets 150 have their nuts torqued with their respective top bolt to be secured in place.

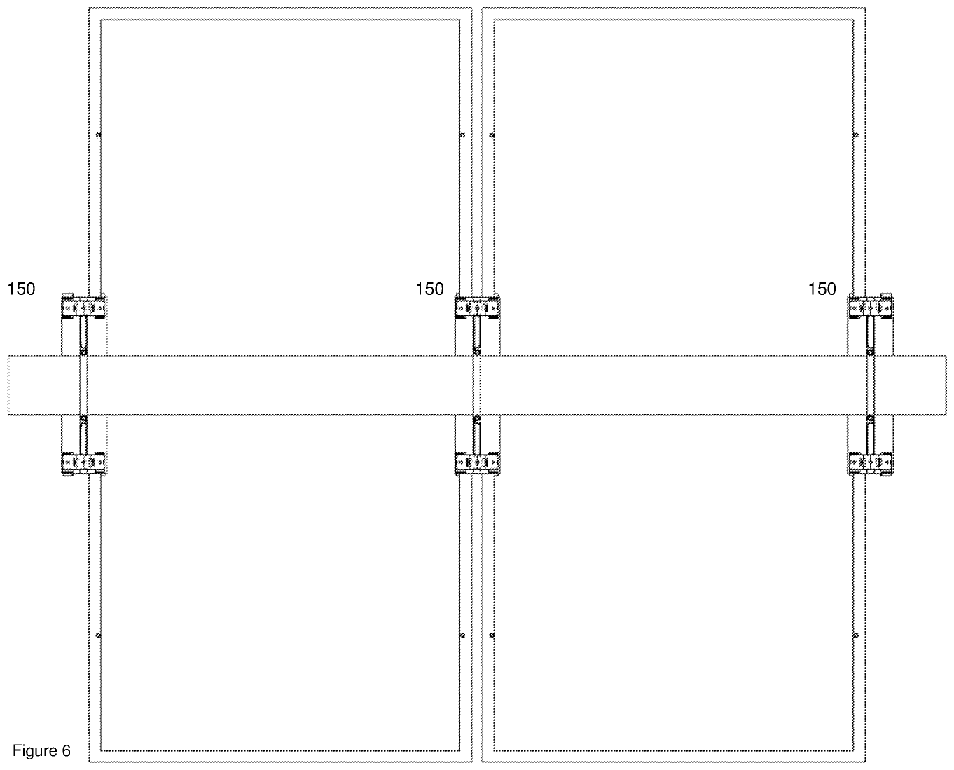

FIG. 6 illustrates a bottom view of three example multiple part brackets aligned on an embodiment of an arm of a solar access tracker joining two solar panel modules.

The three example multiple part brackets 150 join two solar panel modules and the lower shaped bracket [and upper shaped bracket] adapting its shape and dimensions around the arm of this particular type of solar access tracker. In the middle example multiple part bracket 150 a first extension section extends under the first solar panel module as well as extends under the second solar panel module.

A second extension section also extends under the first solar panel module as well as extends under the second solar panel module so that the solar panel modules are secured together.

Each extension section can contain the receiver portion of the clip bracket 180 that snaps in place into the slots of the upper portion of the multiple part bracket 150. Again, the adaptor portion of the clip bracket 180 has a protruding shape that can snap into a recess formed on the bottom side of the solar panel module. The multiple part bracket 150 mechanically and electrically connects both the first solar panel module and the second solar panel module to each other.

For the upper portion of the bracket, the extension section extends long enough so that the, for example, male end of the protruding clip may snap into the female end receptor in the recess of a solar panel module so that the solar panel modules can join and then abut each other.

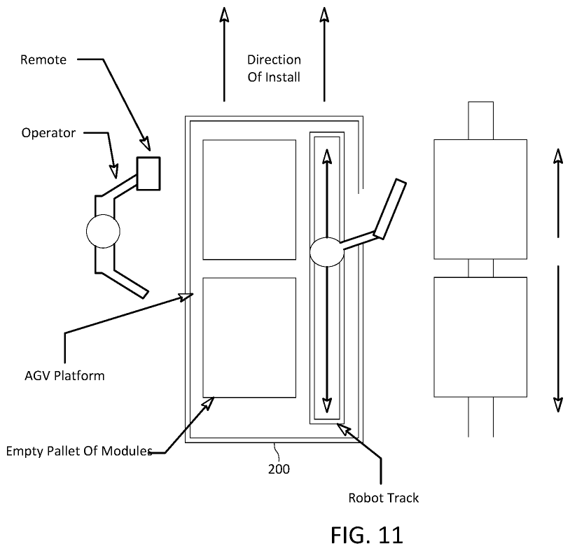

FIG. 11 shows a top-down view of an embodiment of an automated ground vehicle with a robotic arm to work with the solar panel modules to put them in place on an arm of a solar tracker along with the multiple part bracket. In an environment, a follower robot can fasten the brackets. The follower robot can make the first pass with the brackets. The follower robot can space out, and install the brackets 150, 180 to arm/torque tube and torque the brackets via the fastening mechanism down on the arm to the torquing Specification. This is done prior to the autonomous ground vehicle with the robotic arm making its round to do the install of the solar panel module onto the bracket 150, 180.

Again, the hardware of the multiple part bracket 150 for panel mounting can be used with an autonomous ground vehicle (AGV) with a robotic arm 200 for solar panel placement and installation. The multiple part bracket 150 can have a UL listing for wind loading and mounting arm integration. The multiple part bracket 150 and its variants provide multiple custom connector brackets for attachment to a wide family of single-axis solar trackers, such as ATI, NexTracker, GameChange, RBI, etc., with each single-axis solar tracker design having the upper shaped section and lower shaped section of the bracket designed specifically in shape and dimension for that type of single-axis solar tracker.

First, the multiple-part bracket 150 is fastened to the torque tube at a specific distance. This could include the upper/lower/thru bolts, and the receiving end of the clip bracket 180. In another step, the opposing end (that will be mated to the receiver portion of the clip bracket 180) can be installed at the factory or attached in-field into the recess of the solar panel module. On the install, the installer/robot arm will position the panel over the receiver portion of the clip brackets 180 and “snap” the solar panel module in on receiver on both Left/Right sides of the brackets. Once mechanical adapter portion of the clip bracket 180 is snapped into the receiver portion of the clip bracket 180, this would create the mechanical bond between the multiple part bracket 150 and the solar panel module to hold the solar panel module in place. Since the multiple-part bracket 150 is already bolted in place there is no more torquing. Merely, a snap-fit between the adapter portion and the receiver portion of the clip bracket 180 installed in the slot of the multiple part bracket 150 is all the robotic arm needs to do.

In an embodiment, an autonomous follower robot cooperates with the autonomous ground vehicle with a robotic arm 200 to fasten the installed solar panel modules via the use of the mechanical fastener of the multiple part bracket 150 and/or the clip bracket 180. The follower robot can install and secure brackets as a prior task to the solar panel module install by the autonomous ground vehicle with a robotic arm 200.

The autonomous ground vehicle with the robotic arm 200 can be constructed and programmed to autonomously install solar panel modules with the multiple part bracket 150. The robotic arm autonomously installs the multiple part bracket 150 onto a solar tracker to mechanically secure the solar panel module onto the solar tracker as well as make an electrical connection to another solar panel module with the multiple part bracket 150.

Similar to previously described, the robotic arm autonomously installs the multiple part bracket 150 at set distances on an arm of the solar tracker and then installs the solar panel module onto installed multiple part brackets 150.

Alternatively, the robotic arm autonomously installs the multiple part bracket 150 with a solar panel module already attached to that bracket on an arm of the solar tracker.

Similarly, with a few software programming changes, the autonomous ground vehicle with the robotic arm 200 can autonomously install the clip bracket 180 by itself without a multiple part bracket 180. The clip bracket 180 is constructed to be usable with the autonomous ground vehicle with the robotic arm 200 for solar panel installation in order to autonomously install the clip bracket 180 onto a fixed axis solar tracker with the robotic arm. The clip bracket 180 is constructed to mechanically secure a solar panel module onto the fixed axis solar tracker as well as make an electrical connection to another solar panel with the clip bracket 180.

The clip bracket 180 design, in an embodiment, has wheels integrated into an extended portion of that bracket to assist in moving and sliding individual brackets along the arm (e.g., torque tube/C channel/I-beam/box channel) of the fixed axis tracker.

The example autonomous ground vehicle with the robotic arm 200 is configured with circuitry and software to communicate and otherwise cooperate with one or more additional vehicles, such as the follower fastening robot as well as with other additional autonomous ground vehicles that can have wireless communication with the first autonomous ground vehicle to perform the solar panel module installation.

Each autonomous ground vehicle with the robotic arm 200 has a deck with space for one or more pallets of solar panel modules on its deck. An autonomous ground vehicle with the robotic arm 200 can have, for example, a slanted deck section for placing stacks and pallets of solar panel modules onto its deck.

Alternatively, the autonomous ground vehicle with the robotic arm 200 for solar panel module installation can have, for example, an extra-long flat deck section for placing stacks and pallets of solar panel modules onto its deck. The autonomous ground vehicle with the robotic arm 200 may also have another section on its deck where its robotic arm track and robotic arm are located.

The deck of the autonomous ground vehicle with the robotic arm 200 can have an area for placement of two or more pallets of solar panel modules/panels onto the deck, with sensors in that area to determine by any combination of i) by weight, ii) by vision, and/or iii) by count to determine when an amount of remaining solar panel modules on the deck is getting low and/or is empty. The autonomous ground vehicle with the robotic arm 200 may have sensors to measure the weight of the pallets of solar panel modules on the deck of the autonomous ground vehicle with the robotic arm 200 to sense when the amount of solar panel modules on the deck is running low and should send out an automated signal to a material handler to come over to the vehicle with more pallets of solar panel modules to be transferred onto the deck.

The coupling mechanism can mechanically and electrically connect the autonomous ground vehicle with the robotic arm 200 with a vehicle that merely carries additional solar panel modules via e.g., a mechanical hitch and an electrical mating interface. The coupling mechanism can be installed on both the front and a rear of the autonomous ground vehicle 200 for solar panel module placement. During a coupling operation, the autonomous ground vehicle carrying the solar panel modules communicates and cooperates with the autonomous ground vehicle with the robotic arm 200 through the coupling mechanism.

While moving/driving and coupled, the autonomous ground vehicle with the robotic arm 200 can communicate and place the drive system of the autonomous ground vehicle carrying the solar panel modules into a follower mode making the drive system of the autonomous ground vehicle 200 the master. The autonomous ground vehicle with the robotic arm 200 can have its own GPS and a vision system to help find the autonomous ground vehicle carrying solar panel modules, other autonomous ground vehicles with robotic arms, as well as aid in coupling the coupling mechanism between the two. The systems (e.g., computer vision system, GPS, etc.) of the autonomous ground vehicle with the robotic arm 200 can communicate and cooperate with the follower fastening robot to assist when a solar panel module is being installed.

The coupling mechanism also has a de-coupler tool to allow the autonomous ground vehicle with the robotic arm 200 to decouple from a vehicle carrying solar panel modules and have that vehicle go get more solar panel modules.

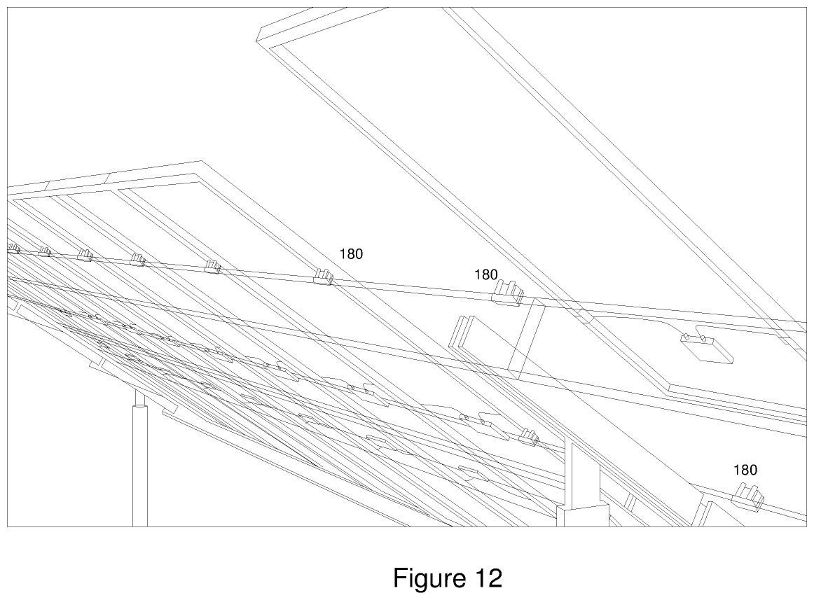

FIG. 12 illustrates an embodiment of a bottom-up perspective view of an embodiment of multiple solar panel modules being set onto arms of a fixed axis solar tracker along with tens of clip brackets in place to clip into the recess cavity in a corresponding solar panel module as well as the electrical adapters portion of the clip bracket connects to electrical power modules for each of the solar power panels. Electrical plugs and their corresponding cords plug into the power module of each solar panel module and then into the electrical adapter of the corresponding clip bracket 180.

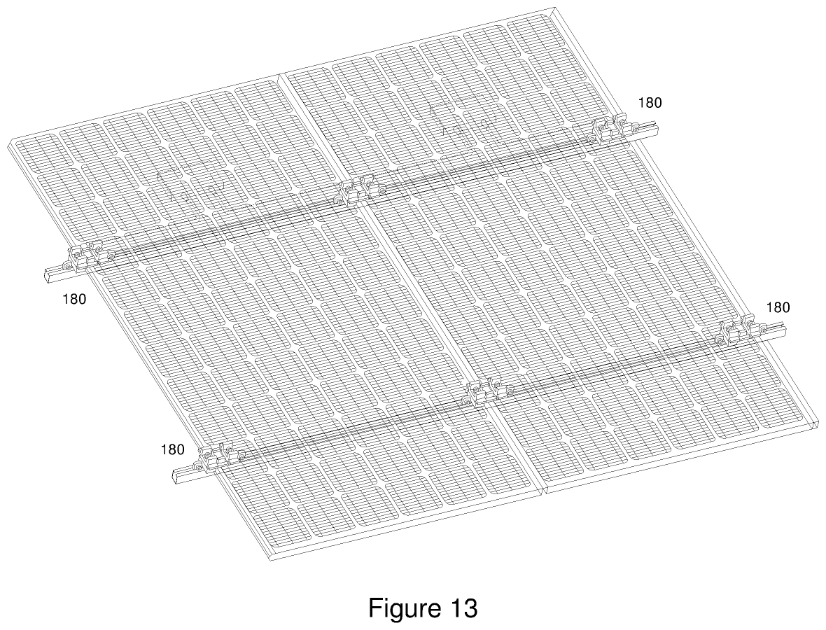

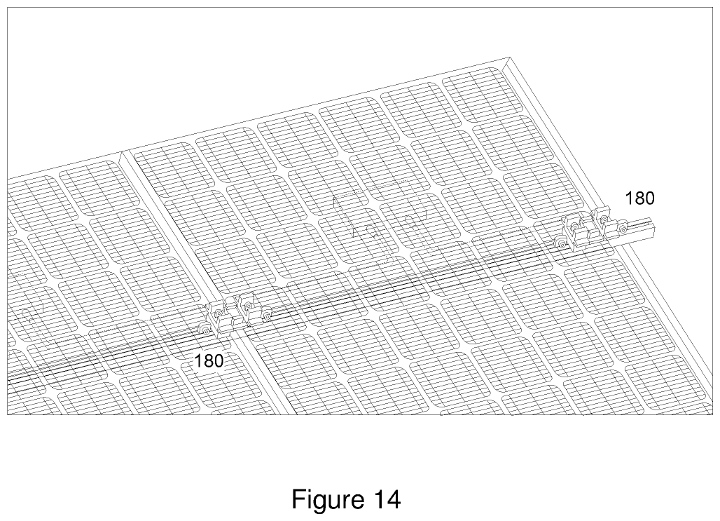

FIG. 13 illustrates a top-down perspective view of an embodiment of six clip brackets each with two mechanical adapter portions of the clip bracket in order to clip into neighboring solar panel modules (e.g., a solar panel module on the left and the solar panel module on the right). Note, a section of the clip bracket extends upwards to snap into place into the solar panel modules. Note, in FIGS. 13 and 14, the solar panel modules are shown opaquely shaded and technically would be on top of the clip brackets 180 but in order to show the clip brackets 180 on the C-channel arms, the solar panel modules have been made translucent so that the top of the clip brackets 180 can be seen better.

The brackets may use standard, listed outdoor electrical rated connectors such as MC4, SAE, Tycho, etc., solar electrical connector with a male end and a female end in order to plug into each other in order to make the electrical connection between one solar panel to the next solar panel or an adjacent solar panel. The brackets may also use a multi-pin plug with a female end and a male end in order to plug into a watertight connect electrical connection between the bracket and the solar panel to form an electrical connection in order to pass the electrical power harnessed by the solar panel downstream to an adjacent solar panels connector and, eventually, out of the row to whatever batteries or other electrical component storing and/or using the power from the solar panels.

The electrical connection as seen will all occur in the green plastic electrical power adapter portion of the clip bracket 180 which connects on one side to a first solar panel module and then on the other side to the second solar panel module. The electrical pathway goes from the power module of the first solar panel module through the electrical power insert clip of the bracket which will carry the electrical signal to the solar panel module.

FIG. 14 shows a magnified view of an embodiment of two of the clip brackets from FIG. 13. Two electrical power modules of the solar panel modules and their cables connecting into the electrical power insert clip of the clip bracket 180 can be seen.

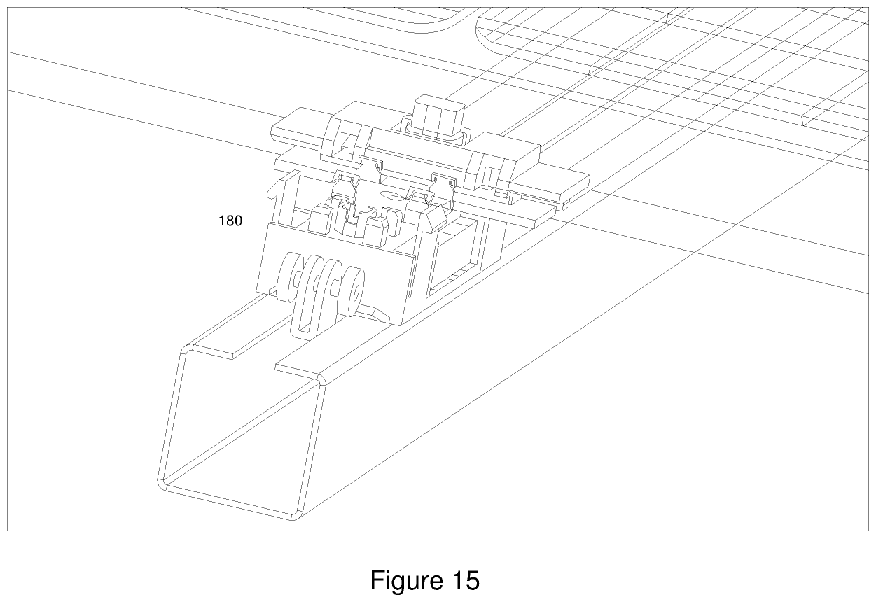

FIG. 15 illustrates a perspective view of a clip bracket along with the mechanical adapter portion extending upward, the electrical power adapter portion as well as the receiver portion of the clip bracket to receiver the adapter portion.

The clip bracket 180 fits into or around an arm of a solar tracker and rides with its wheels in, for example, a box channel shaped arm of a fixed axis tracker. The clip bracket 180 fits into bracket 150 for use in a single axis solar tracker design, or works standalone in a fixed axis solar tracker. The top portion of the clip bracket 180 can protrude upward to connect to the solar panel module and can have a set of wheels, a set of roller guides, and/or bottom made of low friction material (polymers) to help and assist to roll the solar panel module when installed on an arm. The solar panel module can be rolled along the arm into place on that box channel shaped arm.

Fixed axis trackers may use the clip brackets 180 to install solar panels onto arms of those fixed axis trackers, which typically use either C-channel/beams, box channel, and/or I-beams. The clip bracket 180 will have a top portion that mechanically clamps and snaps into place mating the solar panel module to the top portion of the clip bracket 180. The top portion of the clip bracket 180 may have a protruding shape, such as a hexagon, arrow shaped clips, etc., and when the protruding shape is pressed into a recessed cavity with clips in the solar panel module, then the panel and the protruding portion of the bracket will snap into place and be permanently connected to each other unless and until a specialty tool is applied that allows the user to pry back the clips to separate solar panel module and clip bracket 180.

All of the clip brackets 180 can be pre-attached to at least one solar panel module and then can be slid onto the arm (e.g., C-channel or I-beam) of the fixed axis tracker.

The solar panel module with its clip bracket 180 can then be slid along the arm of the fixed axis tracker with its wheel assembly and/or low friction surface as part of the clip bracket 180 until the solar panel module is slid into a permanent position on the fixed axis tracker. The solar panel module can then be mechanically secured permanently in place by adjusting a mechanical fastener on the bracket to clamp the solar panel module in place on the arm.

In an embodiment, the fastening screw can either come from underneath and screw up in order to clamp the bracket into place, or the screw mechanism can be located on the side of the bracket and use a cam or gear system to turn a lock nut into place and screw it and secure the bracket onto the arm of the solar tracker.

The fastening screw can clamp by clamping that clip bracket 180 in place by turning this fastening screw which would turn the cam and/or gears which will then turn the lock nut and eventually tighten it to a point where the fastening screw is locked in place.

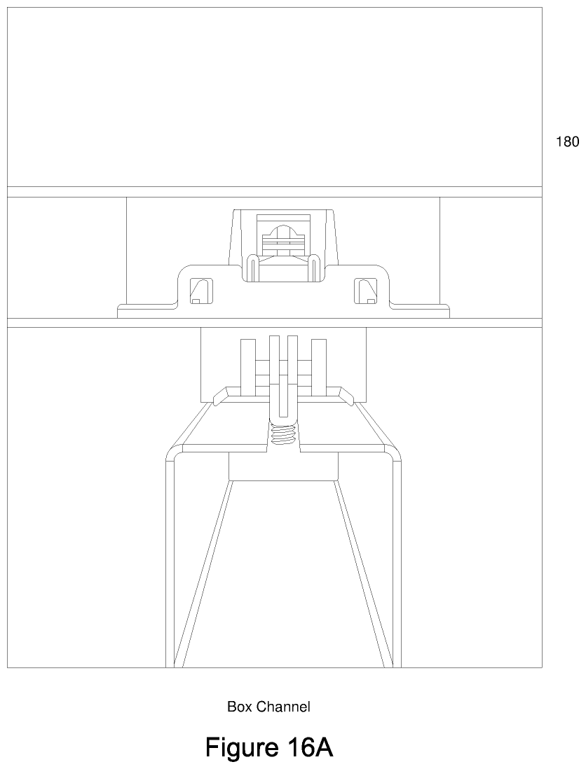

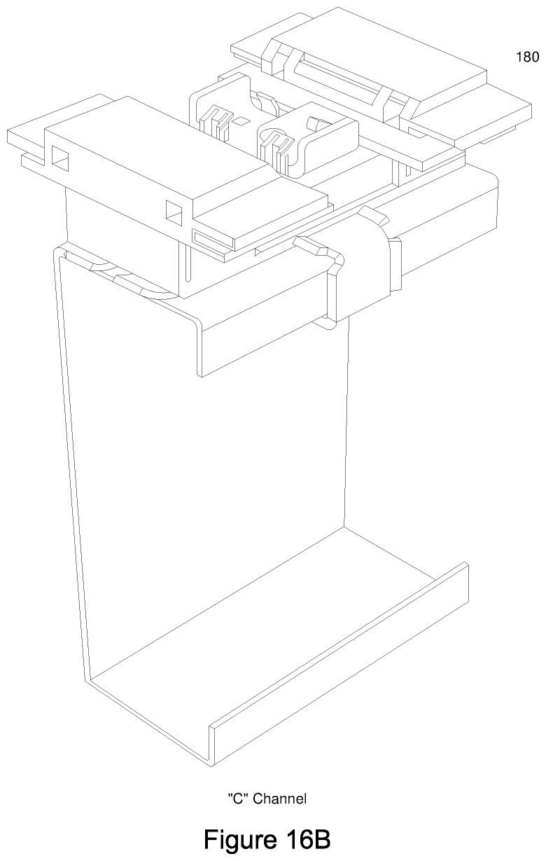

FIG. 16A illustrates a straight-on view of the clip bracket with a portion removed so that you can see the clips of the receiver portion of the clip bracket clipping the adapter portion of the clip bracket in place as well as into the solar panel module and the wheels to allow the solar panel module integrated into the clip bracket to assist in moving the attached solar panel module into place onto the arm of the solar access tracker.

FIG. 16B illustrates a side perspective view of another embodiment of the clip bracket with a C-channel clamp to slide along an arm of a fixed axis solar tracker and two electrical power adapters on top of the clip bracket that can also snap into place into an attached solar panel module.

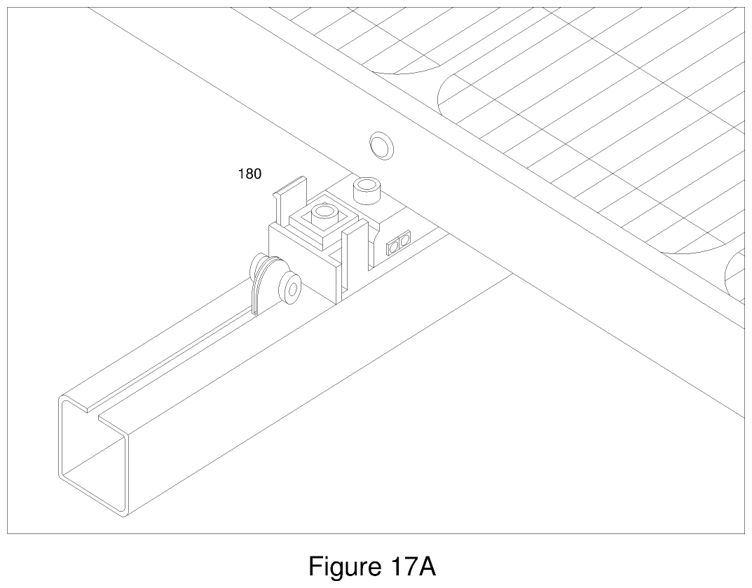

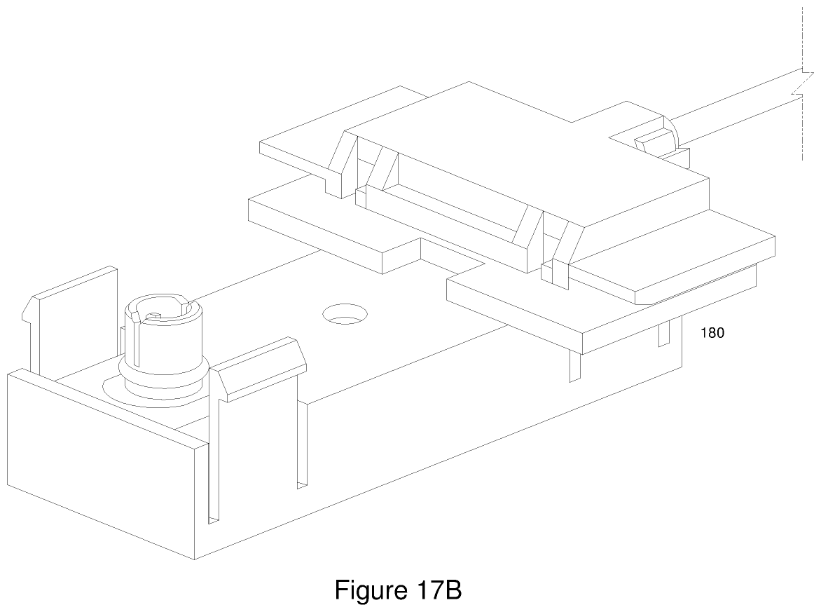

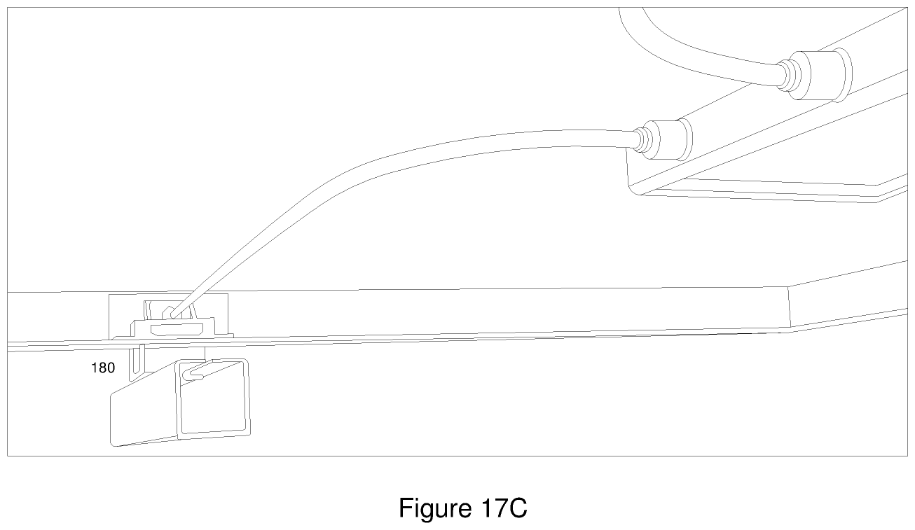

FIG. 17A illustrates a top-down perspective view of an embodiment of a clip bracket with one side of the mechanical adapter portion of the clip bracket snapping into place into the solar panel module and the other receiver portion of the clip bracket open to receive the recess hole of another solar panel module and/or the mechanical adapter portion.

The clip bracket 180 has the integrated wheel and the upward protruding shape to mechanically secure and snap into a second neighboring solar panel module.

FIG. 17B shows a side perspective of an embodiment of a clip bracket with its an electrical power adapter on top.

FIG. 17C shows a side view of an embodiment of a clip bracket with electrical cords plugged into a power module of the solar panel module.

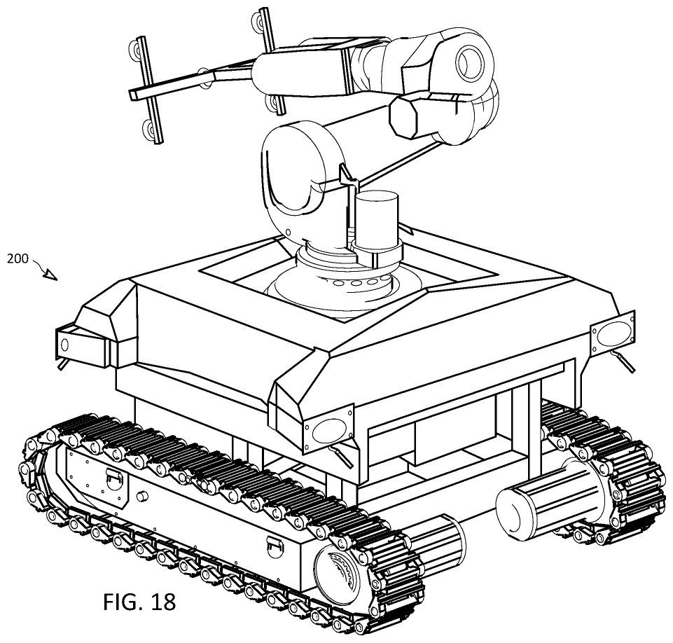

FIG. 18 illustrates a block diagram of an embodiment of an example autonomous ground vehicle with a robotic arm that can autonomously install one or more solar panel module installations onto a solar tracker. Both the multiple part bracket 150 and clip bracket 180 are constructed to be usable with the autonomous ground vehicle with the robotic arm 200 for solar panel installation in order to autonomously install that bracket onto a solar tracker with the robotic arm. Both the multiple part bracket 150 and clip bracket 180 are constructed with an upper portion and a lower portion to be assembled in a field to allow solar panel modules from multiple different manufactures to be installed on the solar tracker.

The whole system for the autonomous solar panel module installation platform for solar panel module installation onto a solar tracker can be used for solar panel module installation in, for example, utility-grade solar farms. The autonomous solar panel module installation platform for solar panel module installation onto a solar tracker can consist of multiple components. Some example components in the system can include:

1. An off-road, autonomous ground vehicle with a robotic arm 200 for solar panel module placement;

2. One or more software coded methods used to install solar panel modules;

3. A set of cooperating autonomous ground vehicles with the robotic arms 200 to carry one or more pallets of solar panel modules in a continuous installation methodology shared between the set of cooperating autonomous ground vehicles with the robotic arms 200; and

4. A cooperating fastening robot to fasten one or more multiple part brackets 150 and/or clip brackets 180 onto an arm of a solar tracker.

The autonomous ground vehicle with the robotic arms 200 can be configured to be autonomous for the entirety of moving along a row of trackers using at least a global positioning system (GPS) to each individual solar tracker and lifting the solar panel modules, at least, into installation position using a vision system onto the corresponding mating mounts on the solar tracker. The off-road capable autonomous ground vehicle with the robotic arm 200 serves as a base. The autonomous ground vehicle with the robotic arm 200 has code and sensors to be autonomous for the entire process of moving along a row of solar trackers and installing solar panel modules onto each solar tracker achieving autonomous operation on its own. The autonomous ground vehicle with the robotic arm 200 can perform every step of the installation process of the solar panel modules onto the tracker, itself achieving more autonomous operation. Alternatively, the autonomous ground vehicle with the robotic arm 200 can hold and hover the solar panel module above the position where the solar panel module needs to integrate onto the arm of the solar tracker and allow a human to guide the solar panel module into the mounting components on the solar tracker for a final step the installation process. The robotic arm can support the weight of the solar panel module during the installation with the human guiding the solar panel module onto the solar tracker in its mounting components. The autonomous ground vehicle with the robotic arm 200 will work in tandem with the human installer to pick up and install solar panel modules onto the solar tracker and then have the human operator fasten and secure the solar panel modules in place. The human can cooperate with the autonomous ground vehicle with the robotic arm 200 to secure and fasten the solar panel when properly positioned onto the tracker in place. The autonomous ground vehicle with the robotic arm 200 also can have the additional capability to incorporate human-operated remote control operations into its own operations of driving and robotic arm operation. In this situation, the autonomous ground vehicle with the robotic arm 200 drives and performs in essence around 90 percent of the operations while the human operator takes over for the final driving and/or solar panel module installation steps. In some situations, it might be easier for a human to assist in the more critical driving and robotic arm operation.

The autonomous ground vehicle with the robotic arm 200 will generally drive the autonomous ground vehicle 200 itself to each solar tracker and align itself with that solar tracker automatically in order to place the solar panel modules onto that solar tracker. The autonomous ground vehicle with the robotic arm 200 can self-drive itself using a vision system such as a camera based-computer vision system and/or LIDAR, sensors, and optionally a remote for assisting in various aspects such as driving. The autonomous ground vehicle with the robotic arm 200 has a self-driving system using self-driving software and sensors, such as a vision system (camera-based vision system, LIDAR vision system, etc.) and other sensors, and a remote for assisting in various aspects, such as driving and robotic arm picking up and placing operations.

By the very nature of solar farms, each row of solar trackers is located on a relatively known location on a map of the solar farm.

Each solar farm has one or more devices that give off precise GPS coordinates. Normally, at least one GPS device is located in a control room of a solar farm. Each solar tracker is usually installed in a pre-planned location on that farm per its planning drawings; and thus, the autonomous ground vehicle with the robotic arm 200 can drive directly to the beginning of each row by using the approximate GPS coordinates of that row of trackers and/or the autonomous ground vehicle with the robotic arm 200 can calculate a distance to a row of solar trackers from a known GPS coordinates and then drive a specific distance and direction from a device on the solar farm that can broadcast or otherwise convey its GPS coordinates in order to eventually arrive at a target solar tracker. In either circumstance, the autonomous ground vehicle with the robotic arm 200 will roughly align itself with each row of solar trackers and then proceed down the row to align itself with each individual solar tracker when installing solar panel modules onto those trackers via GPS based decisions. The GPS-based decisions can be the GPS coordinates directly on the solar tracker and/or calculations of distance and direction from known GPS coordinates. Note, the autonomous ground vehicle with the robotic arm 200 has its own GPS device that it can reference and a memory, processing unit, and software to reference a plot/map of that solar farm. Next, the autonomous ground vehicle with the robotic arm 200 is coded to use its computer vision and/or LIDAR system for fine adjustments to account for any imperfection on how planar/straight the real row of solar trackers is and/or an exact location in the solar farm of each individual solar trackers is and the ground vehicle's positioning relative to the solar tracker for the solar panel module installation and/or removal. The autonomous ground vehicle with the robotic arm 200 can also have a manual steering wheel, accelerometer, and braking system in order for a human to assist in moving the vehicle. Thus, the autonomous ground vehicle with the robotic arm 200 system uses computer vision and GPS coordinates to be able to self-drive around a solar farm, including up and down rows of solar trackers, as well as to autonomously move to individual solar trackers during a solar panel module installation and/or replacement session.

Next, the autonomous ground vehicle with the robotic arm 200 can self-level at least the robotic arm relative to the solar tracker, accounting for a terrain, using 1) a leveling mechanism consisting of any of i) screw actuators, ii) hydraulic cylinders, iii) airbags, iv) pneumatic actuators, and v) any combination of these, at multiple corners of a deck of the autonomous ground vehicle 200 to level the robotic arm on the deck relative to the solar tracker and 2) a level sensor. The leveling mechanism cooperates with the level sensor in order to level relative to the solar tracker. In an embodiment, each corner of the deck of the autonomous ground vehicle with the robotic arm 200 can have self-level actuators such as screw mechanisms, airbags, and/or hydraulic actuators, to level the robotic arm with respect to an individual solar tracker. The self-leveling actuators cooperate with a tilt sensor and/or incline sensor/meter in order to level the robotic arm so calculations for arm positioning algorithms to install and/or uninstall a solar panel module on that type of solar tracker are correct, relative to the particular solar tracker next to it. The self-level actuators will self-level the deck and robotic arm on the deck relative to the tracker and the terrain so that the autonomous ground vehicle with the robotic arm 200 can adapt to any job site conditions; and thus, any deviations particular to the current solar tracker undergoing a solar panel module installation compared to another solar tracker in a given solar farm.

Next, both the robotic cell containing the robotic arm and the mechanical portions of autonomous ground vehicle 200 are designed and constructed to be used off-road and outdoors for installation work on a job site.

The autonomous solar panel module installation platform for solar panel module installation onto a solar tracker is built for off-road (e.g., muddy terrain, sandy terrain, etc.) operation. The off-road autonomous ground vehicle with the robotic arm 200 serves as a mobile base to autonomously move to individual solar trackers in a solar panel module installation.

Again, the autonomous ground vehicle with the robotic arm 200 is coded to autonomously drive itself to the solar tracker and align itself with the solar tracker in order to place one or more solar panel modules onto the solar tracker. The autonomous ground vehicle with the robotic arm 200 has an ability to autonomously drive itself via the use of a computer vision system and/or a LIDAR system cooperating with a GPS sensor and driving software resident in a drive module for the autonomous ground vehicle 200 to drive itself to the solar tracker and align itself with the solar tracker. The driving software is coded to any of 1) drive a route to GPS coordinates of the solar tracker when the solar tracker has a GPS device on that solar tracker and/or when GPS coordinates (e.g., GPS service) is available at a particular solar tracker location and 2) calculate one or more specific distances, directions, and routes from known GPS coordinates on a solar farm to the solar tracker and then drive those distances, directions, and routes to the solar tracker (when GPS service is not possible at the particular solar tracker's location).

In an embodiment, the autonomous ground vehicle with the robotic arm 200 is able to navigate outdoors in off-road construction environments using any of i) a combination of computer vision and LIDAR system, ii) locally remote controlled, iii) by teleoperation (remote operator), and/or iv) by a pre-planned (recorded) route with calculable distances and directions from a known GPS coordinates. The autonomous ground vehicle with the robotic arm 200 can install the solar panel modules and the multiple part bracket 150 and/or clip bracket 180 on multiple different types of solar trackers from different manufacturers, work on flat terrain, work on unleveled terrain, and many other functions. The autonomous ground vehicle with the robotic arm 200 can have one or more of i) off-road deep-tread tires (e.g., off-road agricultural type tires/tractor tires), ii) a tracked belt drive system, and iii) a powerful enough engine to be able to maneuver in tough terrain. The engine of the autonomous ground vehicle with the robotic arm 200 has enough horsepower to drive the several thousand pounds of the ground vehicle with a fully loaded payload capacity of solar panel modules (potentially on a side vehicle) such as 8,000 lbs. or greater. Next, the engine may be battery-operated and/or have a gas-powered engine. The track drive system and/or off terrain deep tread mud tires can be powered through a direct drive system via the electric motor. Each track can be operated independently so that the autonomous ground vehicle with the robotic arm 200 can turn in place easily. Each track being able to move independently of the other track also allows the vehicle to get unstuck easier and be more reliable in off road conditions. The autonomous ground vehicle with the robotic arm 200 system is designed and constructed to be able to move in rough terrain, sandy conditions, and muddy conditions with the heavy weight of the vehicle and its fully loaded stack of solar panel modules. When the autonomous ground vehicle with the robotic arm 200 is designed to cooperate with the follower fastening robot, then each different movable vehicle can have a smaller/less powerful engine.

This autonomous ground vehicle with the robotic arm 200 is a truly agnostic installation robot that installs solar panel modules and the multiple part bracket 150 and/or clip bracket 180 on any solar tracker (tracker manufacturer and type agnostic) and on any grade or terrain (terrain agnostic).

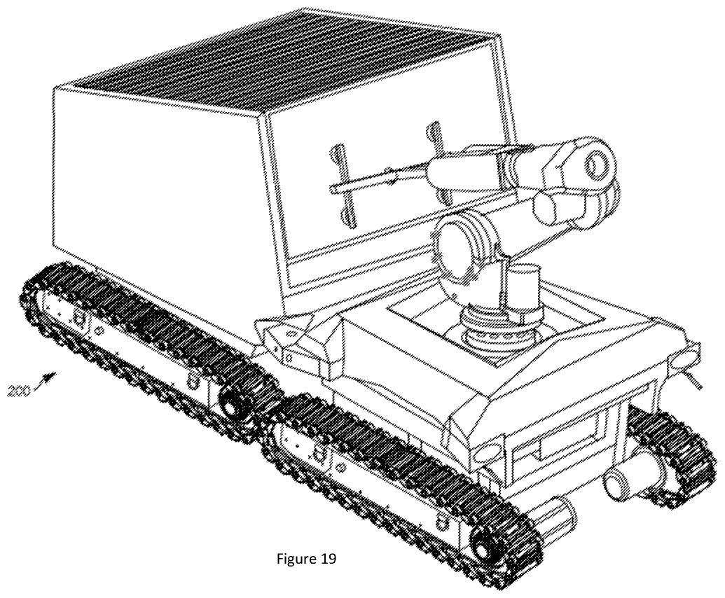

FIG. 19 illustrates a block diagram of an embodiment of an example autonomous ground vehicle with the robotic arm with deck space to carry solar panel modules.

Note, a fleet of two or more vehicles, including the autonomous ground vehicle with the robotic arm 200, can each have a wireless communication system to exchange communications with the vehicles in this fleet, currently installing solar panel modules, to perform the solar panel module installation. A control room in the solar farm, through its own communications module can wirelessly coordinate activities of bringing additional solar panel modules over to the autonomous ground vehicle with the robotic arm 200 currently installing solar panel modules, when an amount of solar panel modules remaining is at or below a threshold amount so that the robotic arm and the autonomous ground vehicle 200 can perform the solar panel module installation on a continuous basis. The autonomous ground vehicle 200 can be configured to wirelessly communicate and otherwise cooperate with one or more additional vehicles directly and/or through the control room. The additional vehicles can be another autonomous ground vehicle when this vehicle is constructed to both carry the solar panel modules and have the robotic arm. However, the additional vehicles can also be two separate types of vehicles that split the functionality into—one type for merely carrying solar panel modules and a second type of vehicle with merely a robotic arm for picking up and placing the solar panel modules onto the solar tracker.

The autonomous ground vehicle with the robotic arm 200 can have a coupling mechanism that mechanically and electrically connects an autonomous ground vehicle with the robotic arm 200 and other vehicles for solar panel module installation. The coupling mechanism also has an electronic release to decouple the autonomous ground vehicle with the robotic arm 200 and the other autonomous ground vehicle merely carrying pallets of solar panel modules and their corresponding multiple part brackets 150 and/or clip brackets 180.

Again, the robotic arm is configured to work with the sensors and coded algorithms to pick up and place the solar panel modules from the deck/container of the autonomous ground vehicle with the robotic arm into position to be connected into the solar tracker. This robotic arm can travel up and down, e.g., a 6-axis or a 7-axis robotic arm track to be able to pick up and place solar panel modules in place while the autonomous ground vehicle 200 remains in place. The autonomous ground vehicle 200 can self-level the platform relative to the tracker and the terrain via its mechanisms discussed herein. The robotic arm can pick up the solar panel module from the deck/container of the autonomous ground vehicle with the robotic arm 200 coupled to either the front or the rear of the autonomous solar panel module installation platform for solar panel module installation. The robotic arm can raise the solar panel module out and over to the solar tracker, and then place the solar panel module very near the panel mounting location on the solar tracker via using the GPS coordinates of the tracker, its computer vision system, and a LIDAR-based system for placing the solar panel modules into the corresponding panel mounting location on the tracker. The robotic arm lifts the solar panel modules into installation position to hover over the tracker mounts. The robotic arm can hold and suspend the weight of the solar panel module and then mechanically follow i) a human's pulling or pushing of the solar panel module or ii) similar controls from a remote control in order to then guide the solar panel module, while the robotic arm holds the weight of the solar panel module, into the panel mounts on the solar tracker. In an embodiment, when the robotic arm has the solar panel module approximate to the panel mounts to the solar tracker, then a person can use a remote control to lower and place the solar panel module into the mounts of the tracker or in some cases guide the panel with his or her hands into the mounts of the tracker. Note, in an embodiment, with the snap fit install, the robot will be able to align the panel to the multiple part bracket mounts and snap the panels into place. In this embodiment. no more need exists for human control.

A construction and shape of a body of a robotic arm are configured to have a range of motion of, at least, 360 degrees. A robotic installation cell is constructed with materials and a powerful enough motor to have a robot arm capable of readily handling a solar panel module weighing 60-200 pounds (lbs.) in low to moderate windy conditions. In an embodiment, the robot arm is constructed to readily handle a solar panel module weighing 60-80 pounds. The robotic installation cell has a multi-axis track to move the robot arm in, for example, 7 axes independently of the platform moving.

The robotic installation cell is configured to cooperate with the GPS and computer vision system to control and determine solar panel module placement. In an embodiment, the robotic arm can pick up the solar panel from a deck, raise the solar panel module out and over to the solar tracker, and then place the solar panel module in place onto the solar tractor via using both the GPS coordinates of the solar tracker and a visual LIDAR-based system for placing the solar panels into the corresponding location onto the solar tracker.

The autonomous ground vehicle is configured to put multiple solar panel modules in place, installed, and secured per each time that the autonomous ground vehicle 200 moves itself and then self-levels in place. The robotic arm can travel forward and backward in the track to place the multiple solar panels in place while the vehicle does not have to move and has self-leveled itself.

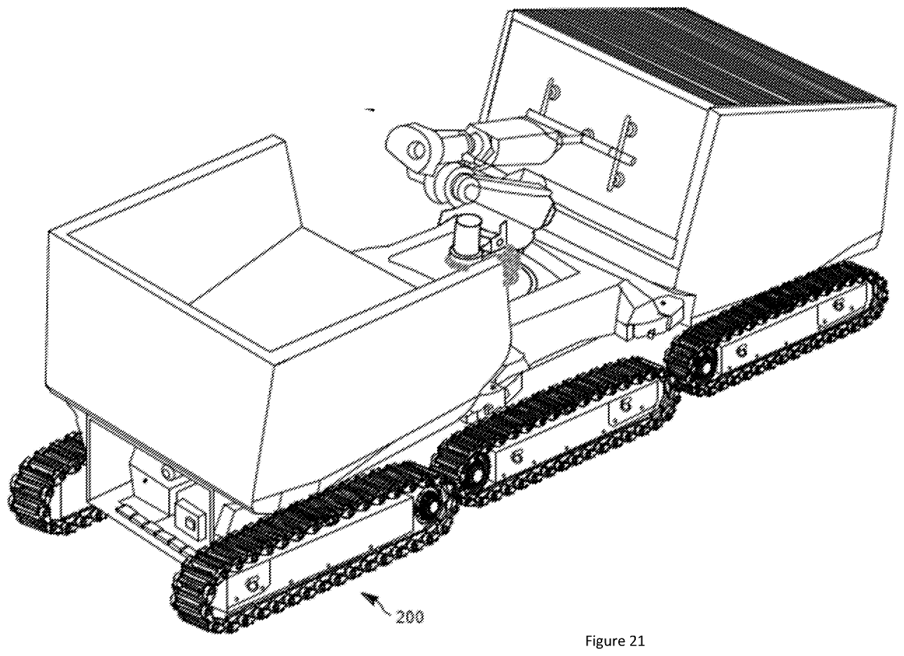

In an embodiment, the robotic cell with the robotic arm is configured to ensure at least two pallets of solar panel modules, one in use and one in the queue are approximate for continuous operations (for example, see FIG. 21). The robotic cell uses weight sensors, and determines when a new pallet is needed and makes a call and sets off a visual signal. The robotic cell has an industrial robotic arm on a robotic 7th axis track to index installation independently from the platform.

This allows the robot to install several modules one after another before running out of track. Once the robot runs out of track to index, the entire platform will move forward and reset the index and recalibrate. The robot arm determines placement using GPS and a vision component. The robot then uses suction cups or other mechanism to pick, place, and hold.

Simultaneously, the robotic cell communicates with the fastener robot and/or cooperating human and waits for an “all fastened” signal to be returned indicating the installation process is complete for that solar panel module.

In an embodiment, a server computing system at the solar farm can be configured to display information in a window, a web page, or the like. An application including any program modules, applications, services, processes, and other similar software executable when executed on, for example, the server computing system can cause the server computing system to display windows and user interface screens in a portion of a display screen space.

Each application has a code scripted to perform the functions that the software component is coded to carry out such as presenting fields to take details of desired information. Algorithms, routines, and engines within, for example, the server computing system can take the information from the presenting fields and put that information into an appropriate storage medium such as a database.

A comparison wizard can be scripted to refer to a database and make use of such data. The applications may be hosted on, for example, the server computing system and served to the specific application or browser of, for example, on the client computing system of the autonomous ground vehicle and its robotic arm.

The applications then serve windows or pages that allow the entry of details.

### Computing Systems

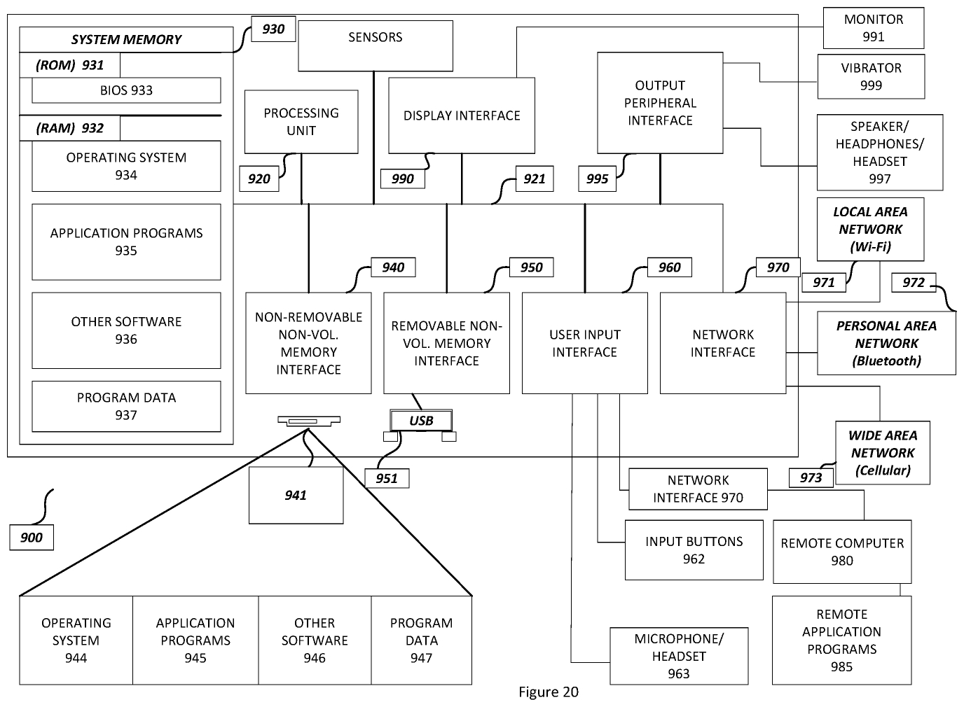

FIG. 20 illustrates a diagram of an embodiment of one or more computing devices that can be a part of the systems associated with the system and vehicles for the autonomous ground vehicle with the robotic arm for solar module installation onto a solar tracker. The computing device 900 may include one or more processors or processing units 920 to execute instructions, one or more memories 930-932 to store information, one or more data input components 960-963 to receive data input from a user of the computing device 900, one or more modules that include the management module, a network interface communication circuit 970 to establish a communication link to communicate with other computing devices external to the computing device, one or more sensors where an output from the sensors is used for sensing a specific triggering condition and then correspondingly generating one or more preprogrammed actions, a display screen 991 to display at least some of the information stored in the one or more memories 930-932 and other components. Note, portions of this system that are implemented in software 944, 945, 946 may be stored in the one or more memories 930-932 and are executed by the one or more processors 920.

The system memory 930 includes computer storage media in the form of volatile and/or nonvolatile memory such as read-only memory (ROM) 931 and random access memory (RAM) 932. These computing machine-readable media can be any available media that can be accessed by computing system 900. By way of example, and not limitation, computing machine-readable media use includes storage of information, such as computer-readable instructions, data structures, other executable software, or other data.

Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 900.

Transitory media such as wireless channels are not included in the machine-readable media. Communication media typically embody computer-readable instructions, data structures, other executable software, or other transport mechanism and includes any information delivery media.

The system further includes a basic input/output system 933 (BIOS) containing the basic routines that help to transfer information between elements within the computing system 900, such as during start-up, is typically stored in ROM 931. RAM 932 typically contains data and/or software that are immediately accessible to and/or presently being operated on by the processing unit 920. By way of example, and not limitation, the RAM 932 can include a portion of the operating system 934, application programs 935, other executable software 936, and program data 937.

The computing system 900 can also include other removable/non-removable volatile/nonvolatile computer storage media. By way of example only, the system has a solid-state memory 941.

The solid-state memory 941 is typically connected to the system bus 921 through a non-removable memory interface such as interface 940, and USB drive 951 is typically connected to the system bus 921 by a removable memory interface, such as interface 950.

A user may enter commands and information into the computing system 900 through input devices such as a keyboard, touchscreen, or software or hardware input buttons 962, a microphone 963, a pointing device and/or scrolling input component, such as a mouse, trackball or touch pad. These and other input devices are often connected to the processing unit 920 through a user input interface 960 that is coupled to the system bus 921, but can be connected by other interface and bus structures, such as a parallel port, game port, or a universal serial bus (USB). A display monitor 991 or other type of display screen device is also connected to the system bus 921 via an interface, such as a display interface 990. In addition to the monitor 991, computing devices may also include other peripheral output devices such as speakers 997, a vibrator 999, and other output devices, which may be connected through an output peripheral interface 995.

The computing system 900 can operate in a networked environment using logical connections to one or more remote computers/client devices, such as a remote computing system 980. The remote computing system 980 can a personal computer, a mobile computing device, a server, a router, a network PC, a peer device or other common network node, and typically includes many or all of the elements described above relative to the computing system 900. The logical connections can include a personal area network (PAN) 972 (e.g., Bluetooth®), a local area network (LAN) 971 (e.g., Wi-Fi), and a wide area network (WAN) 973 (e.g., cellular network), but may also include other networks such as a personal area network (e.g., Bluetooth®). Such networking environments are commonplace in offices, enterprise-wide computer networks, intranets and the Internet. A browser application may be resonant on the computing device and stored in the memory.

When used in a LAN networking environment, the computing system 900 is connected to the LAN 971 through a network interface 970, which can be, for example, a Bluetooth® or Wi-Fi adapter. When used in a WAN networking environment (e.g., Internet), the computing system 900 typically includes some means for establishing communications over the WAN 973. With respect to mobile telecommunication technologies, for example, a radio interface, which can be internal or external, can be connected to the system bus 921 via the network interface 970, or other appropriate mechanism. In a networked environment, other software depicted relative to the computing system 900, or portions thereof, may be stored in the remote memory storage device. By way of example, and not limitation, the system has remote application programs 985 as residing on remote computing device 980. It will be appreciated that the network connections shown are examples and other means of establishing a communications link between the computing devices that may be used.

As discussed, the computing system 900 can include mobile devices with a processing unit 920, a memory (e.g., ROM 931, RAM 932, etc.), a built-in battery to power the computing device, an AC power input to charge the battery, a display screen, and a built-in Wi-Fi circuitry to wirelessly communicate with a remote computing device connected to the network.

It should be noted that the present design can be carried out on a computing system such as that described with respect to shown herein.

However, the present design can be carried out on a server, a computing device devoted to message handling, or on a distributed system in which different portions of the present design are carried out on different parts of the distributed computing system.

In some embodiments, software used to facilitate algorithms discussed herein can be embedded onto a non-transitory machine-readable medium.

A machine-readable medium includes any mechanism that stores information in a form readable by a machine (e.g., a computer). For example, a non-transitory machine-readable medium can include read-only memory (ROM); random access memory (RAM); magnetic disk storage media; optical storage media; flash memory devices; Digital Versatile Disc (DVD's), EPROMs, EEPROMs, FLASH memory, magnetic or optical cards, or any type of media suitable for storing electronic instructions.

Note, an application described herein includes but is not limited to software applications, mobile applications, and programs that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to the desired result. The steps are those requiring physical manipulations of physical quantities.

Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as C, C++, HTTP, Java, Python, or other similar languages. Also, an algorithm can be implemented with lines of code in software, configured logic gates in software, or a combination of both. In an embodiment, the logic consists of electronic circuits that follow the rules of Boolean Logic, software that contain patterns of instructions, or any combination of both. Any portions of an algorithm implemented in software can be stored in an executable format in portion of a memory and are executed by one or more processors. In an embodiment, a module can be implemented with electronics hardware such as electronic circuits including transistors, software blocks of functionality such as an application, routine, algorithm, etc., and combinations of the software cooperating with an electronic circuit.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

A module may be implemented with software stored in a memory executed by a processor, electronic circuitry, and a combination of both. Many functions performed by electronic hardware components can be duplicated by software emulation. Thus, a software program written to accomplish those same functions can emulate the functionality of the hardware components in input-output circuitry.

Thus, provided herein are one or more non-transitory machine-readable medium configured to store instructions and data that when executed by one or more processors on the computing device of the foregoing system, causes the computing device to perform the operations outlined as described herein.

References in the specification to “an embodiment,” “an example”, etc., indicate that the embodiment or example described may include a particular feature, structure, or characteristic, but every embodiment may not necessarily include the particular feature, structure, or characteristic, although each embodiment can include that feature. Such phrases can but are not required to necessarily refer to the same embodiment.

Further, when a particular feature, structure, or characteristic is described in connection with an embodiment, it is believed to be within the knowledge of one skilled in the art to combine such feature, structure, or characteristic in connection with other embodiments whether or not explicitly indicated.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

What is claimed is:

1. An apparatus, comprising:
a multiple part bracket is constructed to be usable with an autonomous ground vehicle with a robotic arm for solar panel module installation in order to autonomously install the multiple part bracket onto a solar tracker with the robotic arm, where the multiple part bracket is constructed to mechanically secure a solar panel module onto the solar tracker as well as make an electrical connection to another solar panel module with the multiple part bracket.

2. The apparatus of claim 1, where the multiple part bracket is constructed with an upper portion and a lower portion to be assembled in a field to allow solar panel modules from multiple different manufactures to be installed on the solar tracker.

3. An apparatus, comprising:
a multiple part bracket is constructed to provide an electrical power connection and a mechanical attachment, where the multiple part bracket includes an upper portion of the multiple part bracket and a lower portion of the multiple part bracket configured to be assembled together on an arm of a solar tracker in a field, where the lower portion of the bracket is configured to be adaptable in shape and dimensions to attach onto solar trackers from two or more different manufacturers in order to mechanically capture a solar panel module on the arm and to retain the solar panel module in place on the arm of the solar tracker.

4. The apparatus of claim 3, where the multiple part bracket is further constructed to use a mechanical fastener in the bracket to secure to arm of the solar tracker via clamping, where the solar panel module will connect to the multiple part backet to remain in place, as well as use a clip bracket containing electrical power circuitry with at least one of an electrical cord, a female electrical plug receptor, and an electrical clip to make an electrical connection to an adjacent solar panel.

5. The apparatus of claim 3, where the lower portion of the multiple part bracket is constructed to adapt its shape and dimensions to match a shape and dimensions of the arm of the solar tracker from that particular manufacturer, where the shape and dimensions of the arm of a first solar tracker from a first manufacturer differs from the shape and dimensions of the arm of a second solar tracker from a second manufacturer, and the upper portion of the multiple part bracket is constructed to mechanically clamp and snap into place when mating to the solar panel module to the upper portion of the bracket.

6. The apparatus of claim 3, where each instance of the lower portion of the multiple part bracket is constructed to mate and connect to a same upper portion of the multiple part bracket and use a same mechanical fastener to secure the multiple part bracket onto the solar tracker of that particular manufacturer.

7. The apparatus of claim 3, further comprising:
where the multiple part bracket is configured to incorporate a clip bracket as a waterproof electrical power insert into open slots of the upper portion of the multiple part bracket, where the clip bracket is configured to contain the electrical connections used to electrically connect adjacent solar panel modules electrically as well as provide an electrical grounding between adjacent solar panel modules.

8. The apparatus of claim 3, further comprising:
an extension section of the upper portion of the bracket is configured to extend out long enough past an edge of the solar panel mounted to that bracket in order for a clip bracket incorporated into the extension section to connect with an adjacent solar panel so that the extension section of the bracket can connect into two adjacent panels, where the clip bracket in the extension section of the upper portion of the bracket is configured to connect into each solar panel module in order to hold neighboring solar panel modules to abut together.

9. The apparatus of claim 3, where the upper portion of the multiple part bracket is constructed with an upper shaped section and a top metal plate with two or more stamped slots in the top metal plate, where the upper shaped section and the top metal plate with the stamped slots are configured to mechanically couple with a lower shaped section in the lower portion of the multiple part bracket via a use of threaded rods, where the threaded rods in the lower shaped section are constructed to be inserted and torqued in place in a factory with at least one of i) nuts and ii) threaded inserts so that the threaded rods can go up and through both the upper shaped section and then through the top metal plate when installed on the arm in a field.

10. An apparatus, comprising:
a clip bracket constructed to be usable with an autonomous ground vehicle with a robotic arm for solar panel module installation in order to autonomously install the clip bracket onto a fixed axis solar tracker with the robotic arm, where the clip bracket is constructed to mechanically secure a solar panel module onto an arm of the fixed axis solar tracker as well as make an electrical connection to another solar panel module with the clip bracket.

11. A method for a multiple part bracket used for a solar panel module, comprising:
configuring a multiple part bracket to be usable with an autonomous ground vehicle with a robotic arm for solar panel module installation in order to autonomously install the multiple part bracket onto a solar tracker with the robotic arm, where the multiple part bracket is constructed to mechanically secure a solar panel module onto the solar tracker as well as make an electrical connection to another solar panel module with the multiple part bracket.

12. The method of claim 11, where the multiple part bracket is constructed with an upper portion and a lower portion to be assembled in a field to allow solar panel modules from multiple different manufactures to be installed on the solar tracker.

13. A method for a multiple part bracket used for a solar panel module, comprising:
configuring a multiple part bracket to provide an electrical power connection and a mechanical attachment, where the multiple part bracket includes an upper portion of the bracket and a lower portion of the bracket configured to be assembled together on an arm of a solar tracker in a field, and
configuring the lower portion of the bracket to be adaptable in shape and dimensions to attach onto solar trackers from two or more different manufacturers in order to mechanically capture a solar panel module on the arm and to retain the solar panel module in place on the arm of the solar tracker.

14. The method of claim 13, further comprising:
configuring the multiple part bracket to use a mechanical fastener in the bracket to secure to arm of the solar tracker via clamping, where the solar panel module will connect to the multiple part backet to remain in place, as well as use a clip bracket containing electrical power circuitry with at least one of an electrical cord, a female electrical plug receptor, and an electrical clip to make an electrical connection to an adjacent solar panel.

15. The method of claim 13, further comprising:
configuring the lower portion of the multiple part bracket to adapt its shape and dimensions to match a shape and dimensions the arm of the solar tracker from that particular manufacturer, where the shape and dimensions of the arm of a first solar tracker from a first manufacturer differs from the shape and dimensions of the arm of a second solar tracker from a second manufacturer, and
configuring an adapter portion of a clip part bracket snap fit into the multiple part bracket to mechanically clamp and snap into place when mating to the solar panel module to the upper portion of the adapter portion of the clip bracket.

16. The method of claim 13, further comprising:
configuring each instance of the lower portion of the multiple part bracket to mate and connect to a same upper portion of the multiple part bracket and use a same mechanical fastener to secure the multiple part bracket onto the solar tracker of that particular manufacturer.

17. The method of claim 13, further comprising:
configuring the multiple part bracket to incorporate a clip bracket as a waterproof electrical power insert into open slots of the upper portion of the multiple part bracket, where the clip bracket is configured to contain the electrical connections used to electrically connect adjacent solar panel modules electrically as well as provide an electrical grounding between adjacent solar panel modules.

18. The method of claim 13, further comprising:
configuring an extension section of the upper portion of the bracket to extend out long enough past an edge of the solar panel mounted to that bracket in order for a clip bracket incorporated into the extension section to connect with an adjacent solar panel so that the extension section of the bracket can connect into two adjacent panels, and
configuring the clip bracket incorporated into the extension section of the upper portion of the bracket to connect into each solar panel module in order to hold neighboring solar panel modules to abut together.

19. The method of claim 13, further comprising:
configuring the upper portion of the multiple part bracket with an upper shaped section and a top metal plate with two or more stamped slots in the top metal plate, where the upper shaped section and the top metal plate with the stamped slots are configured to mechanically couple with a lower shaped section in the lower portion of the multiple part bracket via a use of threaded rods, where the threaded rods in the lower shaped section are constructed to be inserted and torqued in place in a factory with at least one of i) nuts and ii) threaded inserts so that the threaded rods can go up and through both the upper shaped section and then through the top metal plate when installed on the arm in a field.
